(19) United States
(12) Patent Application Publication
(10) Pub. No.: US 2005/0075950 A1
(43) Pub. Date: Apr. 7, 2005

(54) Methods and systems for managing supply chain participant relationships

(76) Inventors: Daniel R. Lewis, St. Louis, MO (US); David L. Braddock, O'Fallon, IL (US); John F. Cooney, Catawissa, MO (US)

Correspondence Address: John S. Beulick;Armstrong Teasdale LLP, Suite 2600, One Metropolitan Square, St. Louis, MO, 63102, US

(21) Appl. No.: 10/620,496

(22) Filed: Jul. 16, 2003

Related U.S. Application Data
(60) Provisional application No. 60/396,944, filed on Jul. 17, 2002.

(51) Int. Cl. G06F 17/60

(52) U.S. Cl. 705/28

(57) ABSTRACT

A method for managing supply chain relationships between a plurality of participants in the supply chain is described. The method includes receiving electronic messages exchanged between the supply chain participants and parsing the received messages for one or more of participant identifier information and contextual data relating to a business event. The method also includes analyzing a performance criteria for the supply chain based on data parsed from the electronic messages and providing data relating to supply chain management to the relevant participants based on the analysis.

### CROSS REFERENCE TO RELATED APPLICATIONS

This application claims priority of Provisional Patent Application Ser. No. 60/396,944 filed Jul. 17, 2002 which is hereby incorporated by reference in its entirety.

### BACKGROUND OF THE INVENTION

Global supply chain management and inventory control rely on the accurate, consistent resolution of participant identities. Information aggregation is possible only when the system can recognize and resolve the multiple identities that a single actual participant may have within the supply chain. Traditional cross reference techniques are inadequate due to their requirement for one-to-one relationships.

The problem with the traditional model is that it cannot resolve participant identities in a business model where any participant may do business with any other participant, often in several different roles. A traditional relationship model is set forth below.

| Common Participant Identity | Alias/Synonym |
|---|---|
| ABC Incorporated | ABC, Inc. |
| ABC Incorporated | ABC Co. |
| ABC Incorporated | ABC Company |
| ABC Incorporated | ABC |
| . . . | Etc. |

### BRIEF SUMMARY OF THE INVENTION

In one aspect, a method for managing supply chain relationships between a plurality of participants is provided. The method includes receiving electronic messages exchanged between the supply chain participants, parsing the received messages for one or more of participant identifier information and contextual data relating to a business event, and analyzing a performance criteria for the supply chain based on data parsed from the electronic messages. The method further includes providing data relating to supply chain management to the relevant participants based on the analysis.

In another aspect, a method for resolving identities of parties to a transaction from a received electronic message is provided. The method includes identifying an originator of the transaction, determining a context of the transaction, finding an appropriate identifier in a database for the originator and context, and reconciling an identity for a receiver of the message based upon the originator, the context, and the identifier in the database for the originator and context.

In still another aspect, a computer is provided which is programmed to passively observe messages transmitted between participants in a supply chain, identify originators of the messages based on the transmitted data, and determine contexts for the observed messages. The computer is further programmed to find appropriate identifiers in a database for the originators and respective contexts and reconcile identities of the receivers of the messages based upon the originators, the contexts, and the identifiers in the database for the originators and respective contexts.

As explained below in more detail, a supply chain relationship matrix provides a universal participant identity reconciliation process and supporting technology for inter-enterprise and some intra-enterprise supply chain operations. In contrast to typical reconciliation processes that require a common identity for each participant with one-to-one cross reference tables for alternative identities, the relationship matrix uses a context-based, many-to-many relationship model for resolving participant identities.

### BRIEF DESCRIPTION OF THE DRAWINGS

FIG. 1 is a flow diagram illustrating a method for resolving an identity of a participant to a transaction.

FIG. 2 is a diagram illustrating a simple supply chain.

FIG. 3 is a diagram illustrating a supply chain with a drop-shipment relationships.

FIG. 4 is a diagram illustrating a complex supply chain.

FIG. 5 is a block diagram of a sample architecture for a client-server system.

FIG. 6 is a flow diagram illustrating a method for managing a supply chain based on received electronic messages.

FIG. 7 is a flow diagram illustrating general processing associated with a relationship matrix.

FIG. 8 is a flow diagram illustrating an industry code reconciliation process associated with a relationship matrix.

FIG. 9 is a flow diagram illustrating an assigned code reconciliation process associated with a relationship matrix.

FIG. 10 is a flow diagram illustrating a name and address reconciliation process associated with a relationship matrix.

FIG. 11 is a flow diagram illustrating a permissive add process associated with a relationship matrix.

FIG. 12 is a flow diagram illustrating a relationship matrix update process associated with a relationship matrix.

FIG. 13 is an example embodiment of a user interface illustrating a participant list web page.

FIG. 14 is an example embodiment of a user interface illustrating a relationship search criteria web page.

FIG. 15 is an example embodiment of a user interface illustrating a relationship list web page.

FIG. 16 is an example embodiment of a user interface illustrating a participant association tool web page.

FIG. 17 is an example embodiment of a user interface illustrating a product association tool web page.

FIG. 18 is an example embodiment of a user interface illustrating a view participant name synonyms search web page.

FIG. 19A is a portion of an example embodiment of a user interface illustrating a view participant name synonyms web page.

FIG. 19B is a portion of an example embodiment of a user interface illustrating a view participant name synonyms web page.

FIG. 20 is an example embodiment of a user interface illustrating a modify participant name synonyms web page.

FIG. 21 is an example embodiment of a user interface illustrating a product selection criteria web page.

FIG. 22 is an example embodiment of a user interface illustrating a product list web page.

FIG. 23 is an example embodiment of a user interface illustrating a modify product web page.

FIG. 24 is an example embodiment of a user interface illustrating a master product list web page.

FIG. 25 is an example embodiment of a user interface illustrating a participant product list web page.

FIG. 26 is an example embodiment of a user interface illustrating an alert administration web page.

FIG. 27 is an example embodiment of a user interface illustrating a view alerts summary selection criteria web page.

FIG. 28 is an example embodiment of a user interface illustrating a view alerts summary web page.

FIG. 29 is an example embodiment of a user interface illustrating a modify alert detail web page.

FIG. 30 is an example embodiment of a user interface illustrating portions of a shipment user-defined alert rule web page.

FIG. 31 is an example embodiment of a user interface illustrating an alert subscription web page.

FIG. 32 is an example embodiment of a user interface illustrating a view on hand inventory by product web page.

FIG. 33 is an example embodiment of a user interface illustrating a view product in transit summary web page.

FIG. 34 is an example embodiment of a user interface illustrating a ship order list web page.

FIG. 35 is an example embodiment of a user interface illustrating a ship order detail web page.

FIG. 36 is an example embodiment of a user interface illustrating a product movement notice list web page.

FIG. 37 is an example embodiment of a user interface illustrating a view projected availability web page.

FIG. 38 is an example embodiment of a user interface illustrating a modify facility receipt web page.

FIG. 39 is an example embodiment of a user interface illustrating an adjust inventory balances web page.

### DETAILED DESCRIPTION OF THE INVENTION

A supply chain is a group of participants engaged in the buying, transformation, transportation, and selling of products. Typically, each participant in a supply chain has its own perspective on the other supply chain participants, products and relationships within the supply chain. While supply chains may overlap or interact, they do remain distinct. A participant in a supply chain is any uniquely identifiable entity that provides products or services to the supply chain. Therefore, a single large corporation may have a multitude of participants and facilities in a single supply chain (i.e., production, billing, shipping, incoming materials, etc.). A facility is a specific participant location where a product can be tracked, and has physical attributes, for example, size, doors, tanks, hours-of-operation, and average activity rates.

Set forth below is a description of exemplary methods and systems for managing supply chain participant relationships, also known as a relationship manager. The systems and methods are not limited to practice with any particular type of goods or services, and can be used in many different contexts. For example, the systems and methods can be utilized for purchases by a single buyer from one seller, by one buyer from multiple sellers, and by multiple buyers from multiple sellers.

Further, although the various embodiments are described herein in the context of utilization of computers and networks (e.g., local area networks, wide area networks such as the Internet), such embodiments are not limited to practice in electronic form. For example, a buyer who deals with only a very few suppliers for particular types of goods and/or services need not necessarily implement the processes electronically.

While the process described herein need not be implemented electronically, in one embodiment, the relationship manager uses a relational database and application programs. In the example embodiment, an Oracle® database is used, however, any industry standard database could be used. (Oracle is a registered trademark of Oracle Corporation, Redwood City, Calif.) The application program uses techniques involving indices and foreign keys to enable rapid identity resolution. The relationship matrix itself is a table containing at least an originator, context, ID, and receiver.

In one embodiment, the system is a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the system is web enabled and is run on a business-entity's intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

More specifically, an example relationship matrix model is illustrated below. Herein a participant relationship is defined as the identity that one participant uses for another participant in a specific role. The supply chain relationship matrix provides a universal participant identity reconciliation process and supporting technology for inter-enterprise and some intra-enterprise supply chain operations. In contrast to typical reconciliation processes that require a common identity for each participant with one-to-one cross reference tables for alternative identities, the participant relationship matrix uses a context-based, many-to-many relationship model for resolving participant identities.

| Originator | Uses ID | When they | Receiver |
|---|---|---|---|
| ABC, Inc. | XYZ Co. | Buy from | XYZ Company |
| ABC, Inc. | Supplier One | Buy from | XYZ Company |
| JKL Company | Supplier One | Buy from | ABC Company |
| JKL Company | XYZ | Sell to | XYZ Company |
| | Company | | |

A technical effect of the relationship matrix model includes at least facilitating an understanding of the context of a business event when trying to resolve the identities of the participants involved. A further technical effect is that the relationship matrix model enables the system to correctly identify the participants, even when there are apparently conflicting identities in the system. For example, as shown in the table above, the code Supplier One means two different participants depending on the originator and business event.

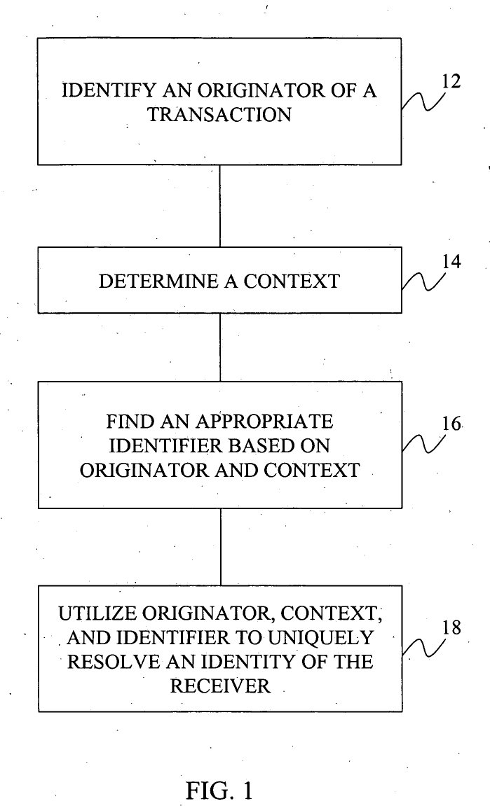

When processing a business transaction, such as a purchase order, the system uses the relationship matrix to resolve the identities of the parties to the transaction. FIG. 1 is a flow diagram 10 illustrating one method for resolving an identity of a party to a transaction. The technical effect of resolving an identity of a party to a transaction, as described herein, is achieved by first identifying 12 the transaction's originator, then determining 14 the context (buying, selling, shipping, etc.), and by finding 16 the appropriate identifier in the matrix for that originator and context. All three elements, originator, context, and ID, are used to uniquely resolve 18 the receiver's identity.

The relationship matrix removes the constraints on the identity relationships and allows the customer to reliably aggregate supply chain activity. This totally eliminates the need for an extra identity reconciliation and aggregation process. Customers can realize a significant improvement in the quality of the aggregate information and a substantial reduction in the time required to create reports that aggregate information by participant.

The difficulty of aggregating information increases geometrically as the number of participant relationships and roles increases. Customers with complex supply chain relationship models will see the greatest benefit from the relationship matrix. The figures and descriptions that follow show only the simplest of relationship combinations that exist in the real world.

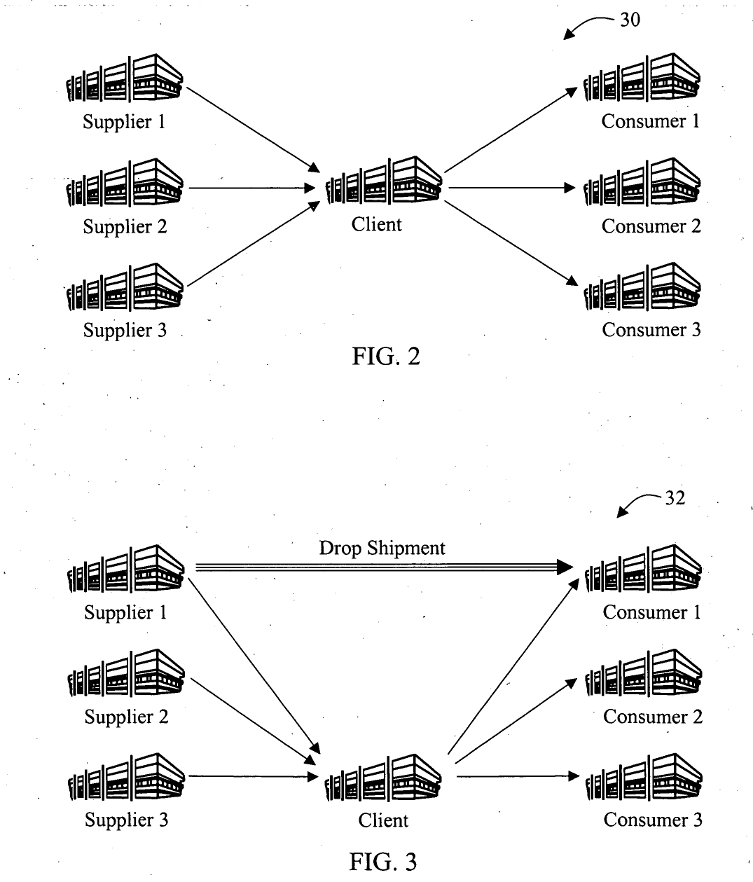

FIG. 2 is a diagram illustrating a simple supply chain 30. In a simple supply chain, the participant's identities are generally controlled by the client, and traditional cross reference table is sufficient. The reality is that there typically are no simple supply chains.

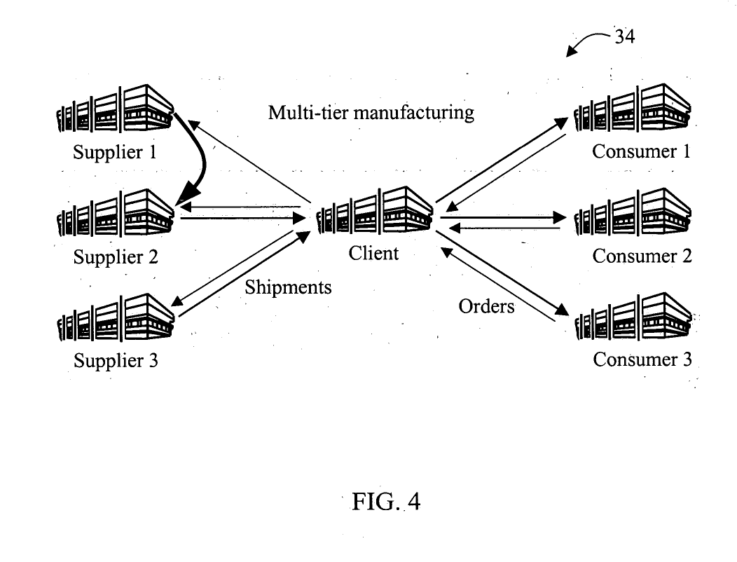

FIG. 3 is a diagram illustrating a supply chain 32 with drop-shipment relationships. In supply chains where drop shipments are frequent, the identity that Supplier 1 uses when selling to Consumer 1 must be resolved as does the identity that the client uses when selling to Consumer 1. The relationship matrix implements this as a statement such as: Supplier 1 uses “code 1” when selling to Consumer 1.

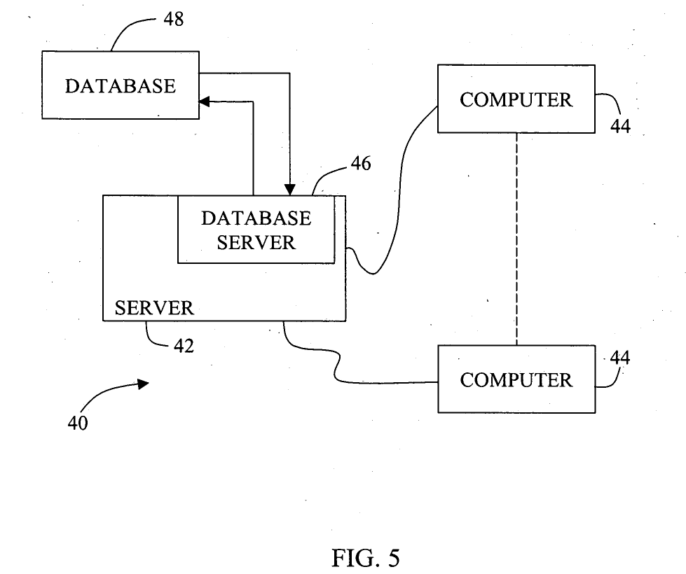

FIG. 4 is a diagram illustrating a complex supply chain 34 with multi-tier manufacturing. Multi-tier manufacturing or distribution operations add significant complexity to the problem of resolving participant identities. In this example, Supplier 1's customer code for Supplier 2 must be resolved against the Client's vendor code for Supplier 2. Without this resolution it becomes difficult, if not impossible, to recognize that a particular shipment from Supplier 1 to Supplier 2 is in fact fulfilling an order from the Client to Supplier 2 and Supplier 1.

The client derives value from the reduced administration required to resolve order and shipment status, and gains the visibility required to plan their own distribution efforts and provide customer service to the consumer.

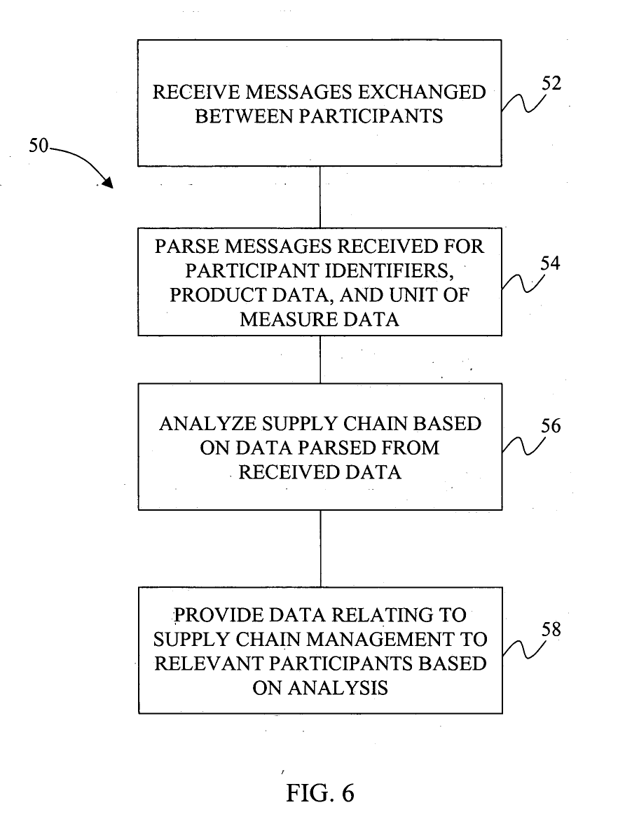

FIG. 5 is a block diagram illustrating an example system architecture which can be utilized in practicing the process. More specifically, FIG. 5 is a block diagram of a system 40 that includes a server sub-system 42, sometimes referred to herein as server, and a plurality of devices 44 connected to server 42. In one embodiment, devices 44 are computers including a web browser, and server 42 is accessible to devices 44 via a network such as an intranet or a wide area network such as the Internet. In an alternative embodiment, devices 44 are servers for a network of devices.

Devices 44 are interconnected to the network, such as a local area network (LAN) or a wide area network (WAN), through many interfaces including dial-in-connections, cable modems and high-speed lines. Alternatively, devices 44 are any device capable of interconnecting to a network including a web-based phone or other web-based connectable equipment. Server 42 includes a database server 46 connected to a centralized database 48. In one embodiment, centralized database 48 is stored on database server 46 and is at one of devices 44 by logging onto server sub-system 42. In an alternative embodiment, centralized database 48 is stored remotely from server 42.

In one embodiment, system 40 receives “copies” of data that are being sent back and forth between the suppliers and consumers, for example, purchase agreements, sales contracts, etc., and as described with respect to FIGS. 2-4. An algorithm, described in further detail below, then identifies individual participants based on their function as included in the contextual relationship data which forms part of the electronic messages. In a specific embodiment, the data messages are passively observed through a web hosting module. As is further described below, system 40 or any other embodiment capable of receiving such messages, utilizes the data received to manage the supply chain relationships between the suppliers and consumers which are hereafter commonly referred to as participants. Through analysis of the data streams that are copied to system 40, snapshots of the entire supply chain and the participants therein can be generated and utilized for management of the supply chain.

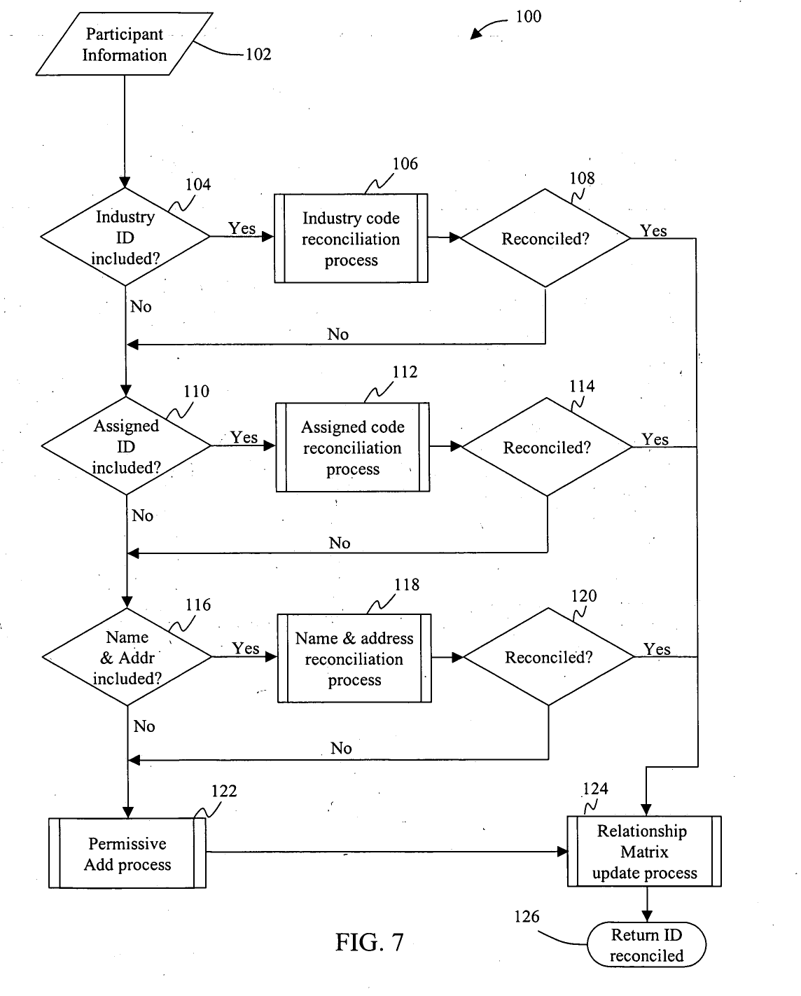

FIG. 6 is a flow diagram 50 illustrating a method for managing supply chain relationships between a plurality of participants. Referring to flow diagram 50, the desired technical effect of the method is achieved when, electronic messages exchanged between the supply chain participants are received 52 and parsed 54 for one or more of participant identifier information and contextual data relating to a business event. Performance criteria, including, but not limited to, facilitating improved inventory efficiency, reducing transportation costs by consolidating shipments, and reduction of excessive inventory backlogs, for the supply chain is analyzed 56 based on data parsed from the electronic messages and data relating to supply chain management is provided 58 to the relevant participants based on the analysis.

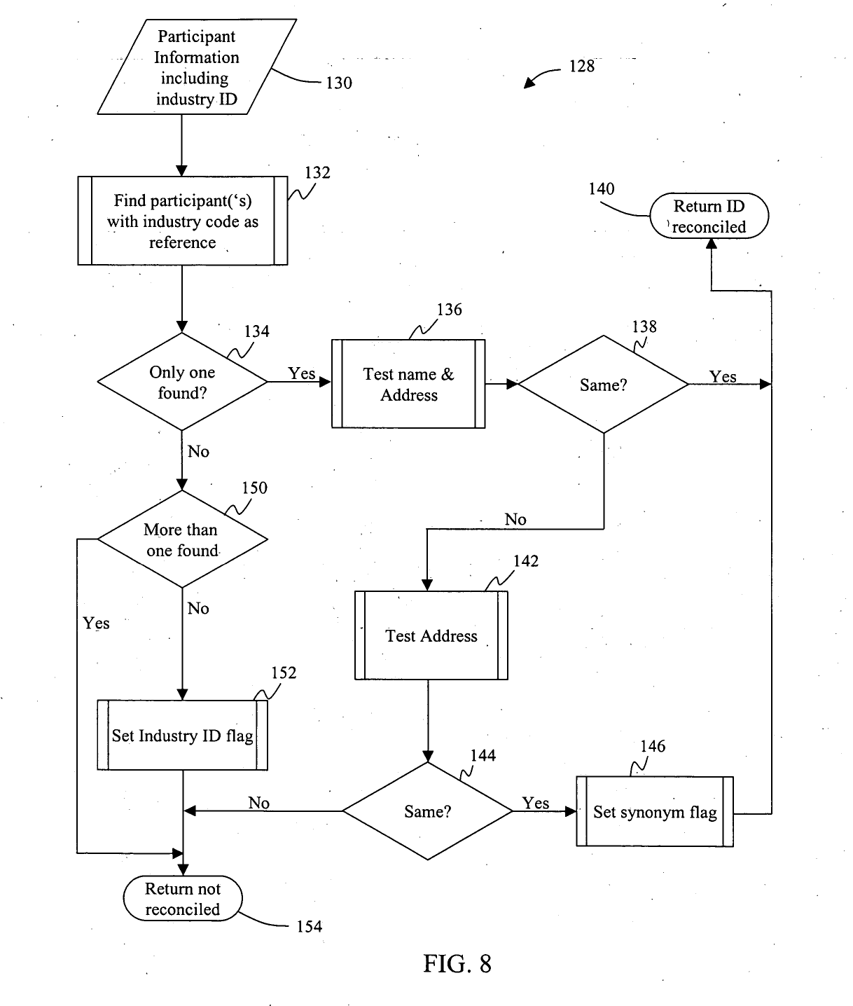

FIG. 7 is a flow diagram 100 that illustrates the general processing associated with data streams received by system 40. Flow diagram 100 is sometimes referred to as a participant relationship matrix. The participant relationship matrix provides a method for reconciling the data received by system 40 to manage the participant relationships to ultimately manage supply chains. Referring to flow diagram 100, the technical effect of system 40 and other embodiment is achieved when participant information, including any identifiers for the participants found in the data received by system 40, and a contextual identifier, are extracted 102 from the data streams transmitted between a supplier and a consumer.

The received participant information is parsed 104 to determine if any industry identifiers for the participants are included in the received participant information. If so, an industry code reconciliation process 106 is activated in an attempt to reconcile 108 the industry identifiers included in the participant information with other industry identifiers presently stored in system 40.

If the industry identifiers cannot be reconciled 108, or if none were provided in the participant information, the received 102 participant information is checked 110 for assigned identifiers. If such assigned identifiers exist, an assigned identifier reconciliation process 112 is activated in an attempt to reconcile 114 the assigned identifiers included in the received participant information with other assigned identifiers presently stored in system 40.

If the assigned identifiers cannot be reconciled 114, or if none were included in the received participant information, the participant information is re-parsed 116 for a name and address of the participants. If such name and address information is included in the received participant information, a name and address reconciliation process 118 is activated in an attempt to reconcile 120 the name and address information included in the participant information with other name and address combinations presently stored in system 40.

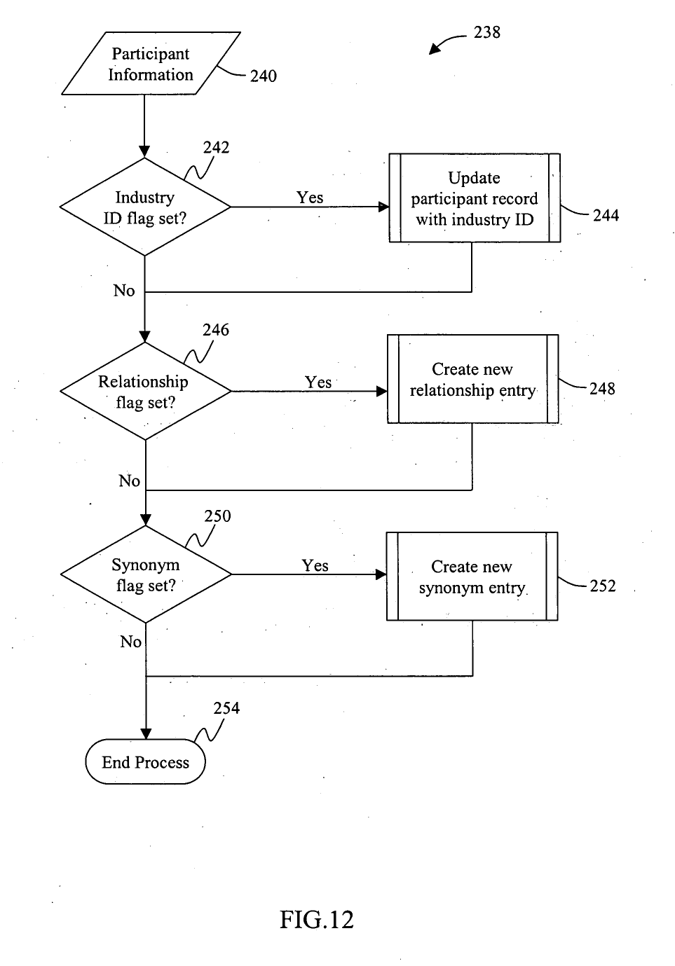

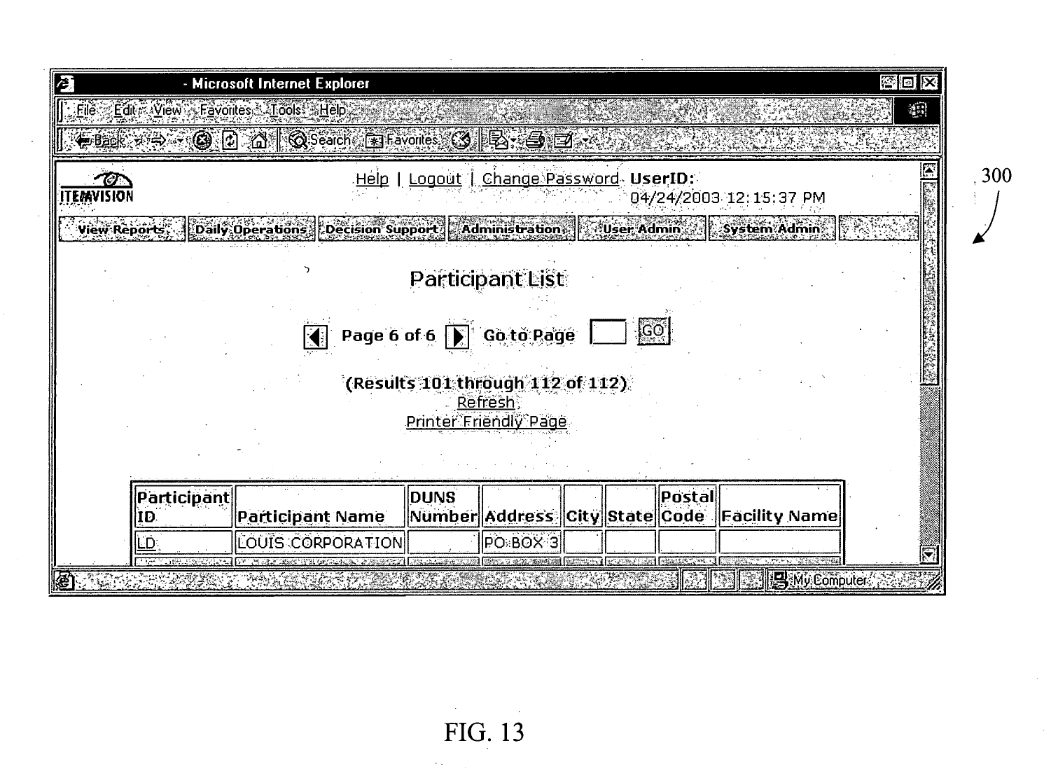

If the name and address cannot be reconciled 114, or if no name and address data was included in the participant information, a permissive add process 122 is activated (shown in FIG. 11 below). Once the permissive add process 122 is completed, or if any of the industry identifiers, assigned identifiers, and the name and address data are reconciled, a relationship matrix update process 124 is activated (shown in FIG. 12 below), which returns 126 reconciled identifiers for the participants.

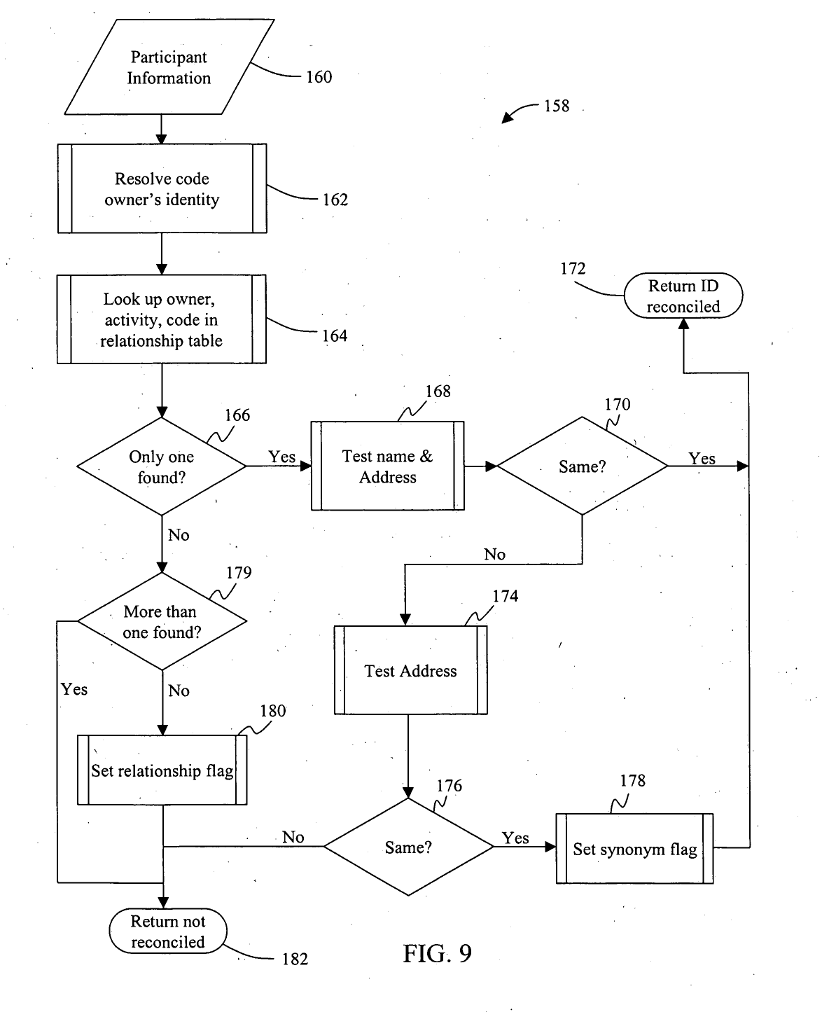

FIG. 8 is a flow diagram 128 illustrating the industry code reconciliation process 106 associated with the relationship matrix (shown in FIG. 7). The technical effect of the code reconciliation process is achieved when the process receives 130 the received participant information, including the industry identifiers for the participants. For each participant, it is determined 132 if other participants use the same industry identifier. If only one other participant is found 134 to be using the industry identifier, the names and addresses for the two participants are tested 136 to see if they are the same 138. If they are the same 138, a reconciled identifier is returned 140. If the names and addresses are not the same 138, a test address process is activated 142. If the addresses are the same 144, a synonym flag is set 146, which indicates that the two participant identifiers are reconciled and returned 140 (based on the industry identifiers and the addresses). If the addresses are not the same, the industry identifier for the participant cannot be reconciled. If multiple participants with matching industry identifiers are found 150, the industry identifier for the participant cannot be reconciled. If no matching industry identifier is found 150, a process to set an industry identifier flag is activated 152, and the process concludes 154 without reconciling the industry identifier.

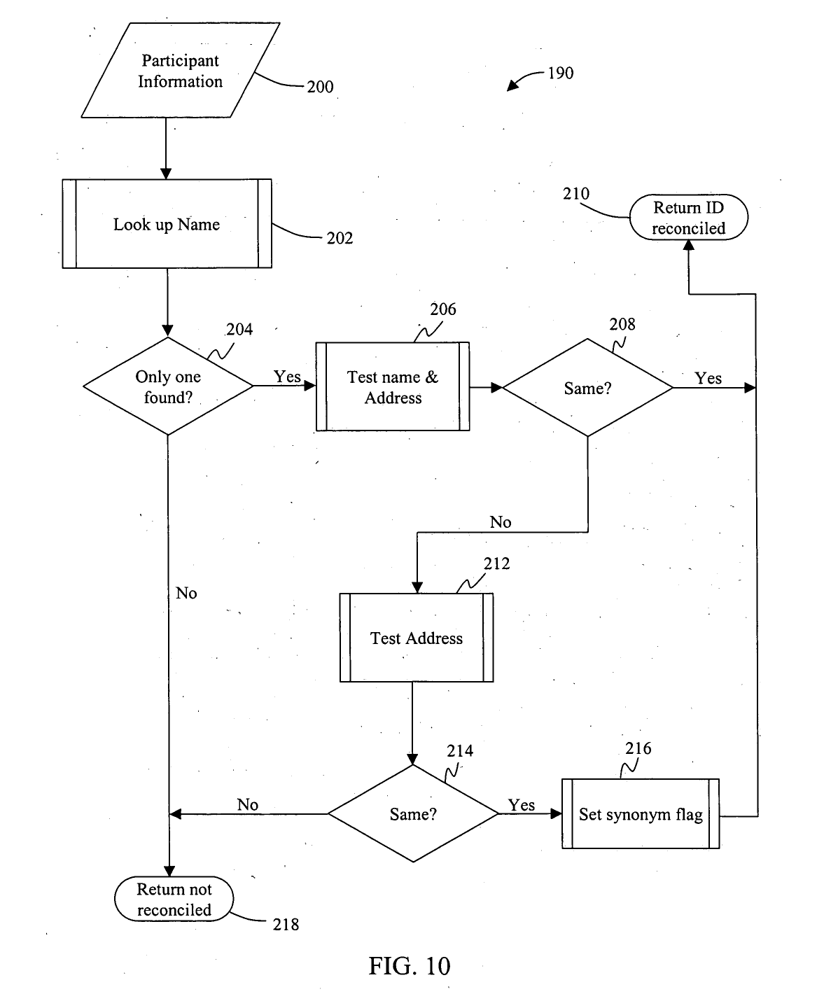

FIG. 9 is a flow chart 158 illustrating the assigned code reconciliation process 112 associated with the relationship matrix (shown in FIG. 7). The assigned code reconciliation process receives 160 participant information, including assigned identifiers for the participants in the data stream, and a resolve identifier owner's identity process is initiated 162. A relationship table is accessed 164 in order to look up the owner, their activity, and their identifier. If only one entry in the table is found 166 that matches the assigned identifier in the participant information, the names and addresses for the two participants are tested 168 to see if they are the same 170. If they are the same 170, a reconciled identifier is returned 172. If the names and addresses are not the same 170, a test address process is activated 174. If the addresses are the same 176, a synonym flag is set 178, which indicates that the two assigned identifiers are reconciled 140 (based on the assigned identifiers and the addresses).

If the addresses are not the same 176, the assigned identifier for the participant cannot be reconciled. If multiple participants with matching assigned identifiers are found 179, the assigned identifier for the participant cannot be reconciled. If no matching industry identifier is found 179, a process to set a relationship flag is activated 180, and the process concludes 182 without reconciling the assigned identifier.

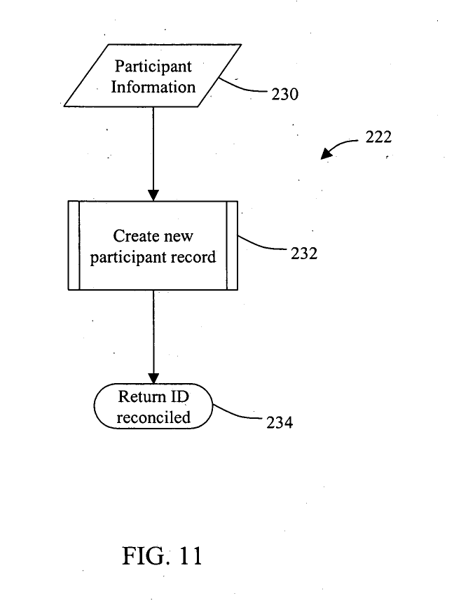

FIG. 10 is a flow diagram 190 illustrating the name and address reconciliation process 118 associated with the relationship matrix (shown in FIG. 7). The name and address reconciliation process 118 receives 200 the participant information found in the data streams transmitted between suppliers and consumers, and a look up name table is accessed 202 to determine if other participants use the name included in the participant information parsed out of the data stream. If only one other participant is found 204 to be using that name, the names and addresses for the two participants are tested 206 to see if they are the same 208. If they are the same 208, a reconciled identifier for that participant is returned 210. If the names and addresses are not the same 208, a test address process is activated 212. If the addresses are the same 214, a synonym flag is set 216, which indicates that the two participant identifiers are reconciled 210 (based on the names and the addresses). If the addresses are not the same 214, the name for the participant cannot be reconciled 218 with the matching name from the look up name table and the process concludes without reconciling the name. If multiple participants with matching names are found 204, the name for the participant cannot be reconciled 218, and the process concludes without reconciling the name.

FIG. 11 is a flow diagram 222 illustrating the permissive add process 122 associated with the relationship matrix (shown in FIG. 7). If no industry identifier, no assigned identifier, or no name and address information is included in the received participant information 230, a new participant record is created 232, and an identifier for the new participant is returned 234 as reconciled. The identifier for the new participant may also be associated with a known participant if necessary.

FIG. 12 is a flow diagram 238 illustrating the relationship matrix update process 124 associated with the relationship matrix (shown in FIG. 7). The relationship matrix update process 124 receives 240 the participant information for the newly added participant and determines whether an industry identifier flag is set 242. If the flag is set 242, a record for the newly added participant is updated 244 to include the industry identifier. If the industry identifier flag is not set 242, or after the participant record is updated, the participant information is parsed to determine whether a relationship flag is set 246. If the flag is set 246, a new relationship entry is created 248 in the record for the newly added participant. If the relationship flag is not set 246, or after the participant record is updated, the participant information is parsed to determine whether a synonym flag is set 250. If the flag is set 250, a new synonym entry is created 252 in the record for the newly added participant, and the relationship matrix update process ends 254.

After receipt of the data streams of participant information, and the above described inspection of those data streams to define relationships between various participants, as described above with respect to FIGS. 5-10, a user may utilize the system incorporating the relationship matrix functionality for supply chain management.

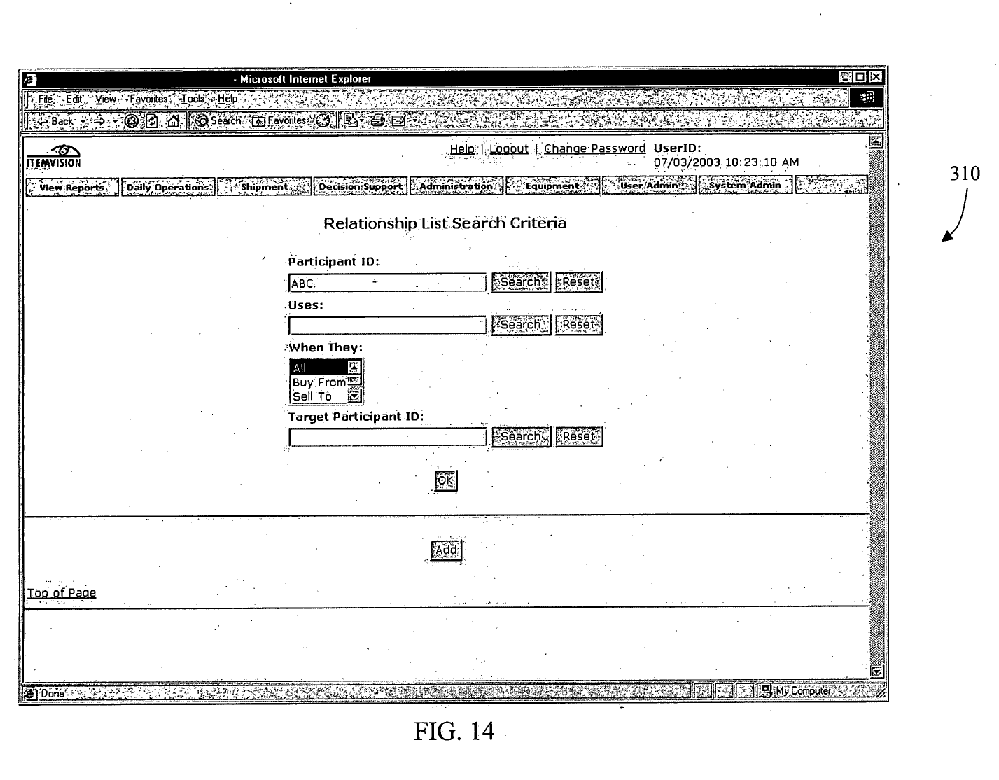

FIG. 13 is an example embodiment of a user interface 300 illustrating a participant list web page which enables a user to view a list of the participants, including a participant ID, a participant name, a DUNS number for each participant, an address, city, state, and postal code for each participant, and various facility names for the participants.

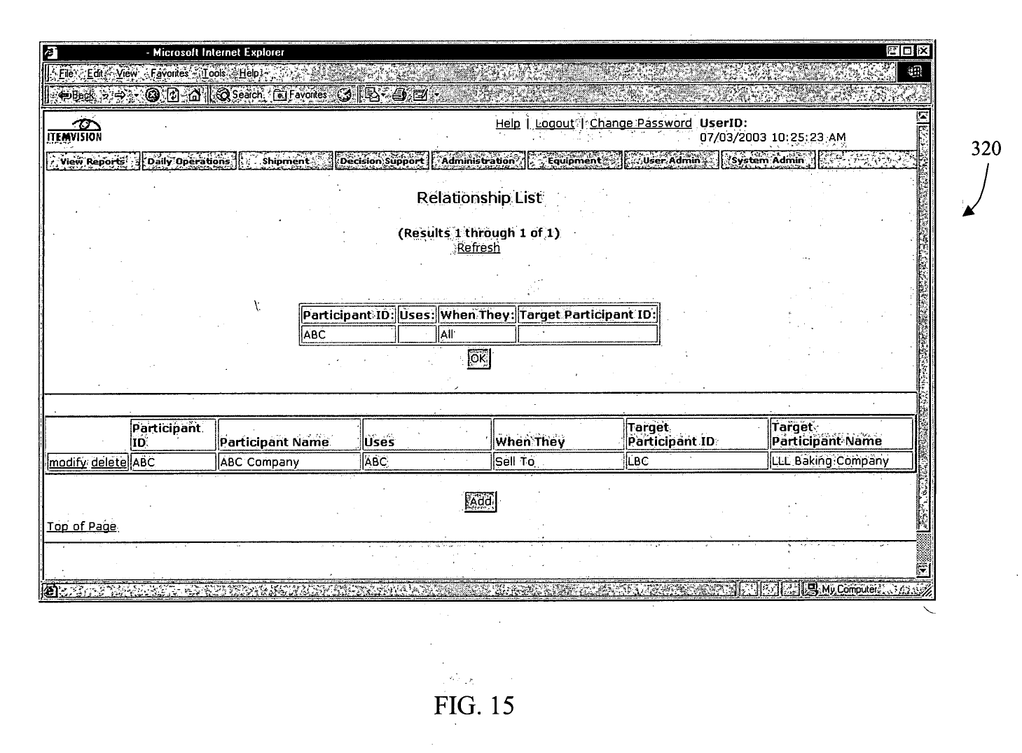

FIG. 14 is an example embodiment of a user interface 310 illustrating a relationship search criteria web page which a user utilizes to search for contextual relationships between participants. the web page provides functionality to allow a user to search, jointly or severally, for participant identifiers, a using field for the participant, and a target participant identifier, based on a relationship (i.e. buys from, sells to) between the participant and the target participants.

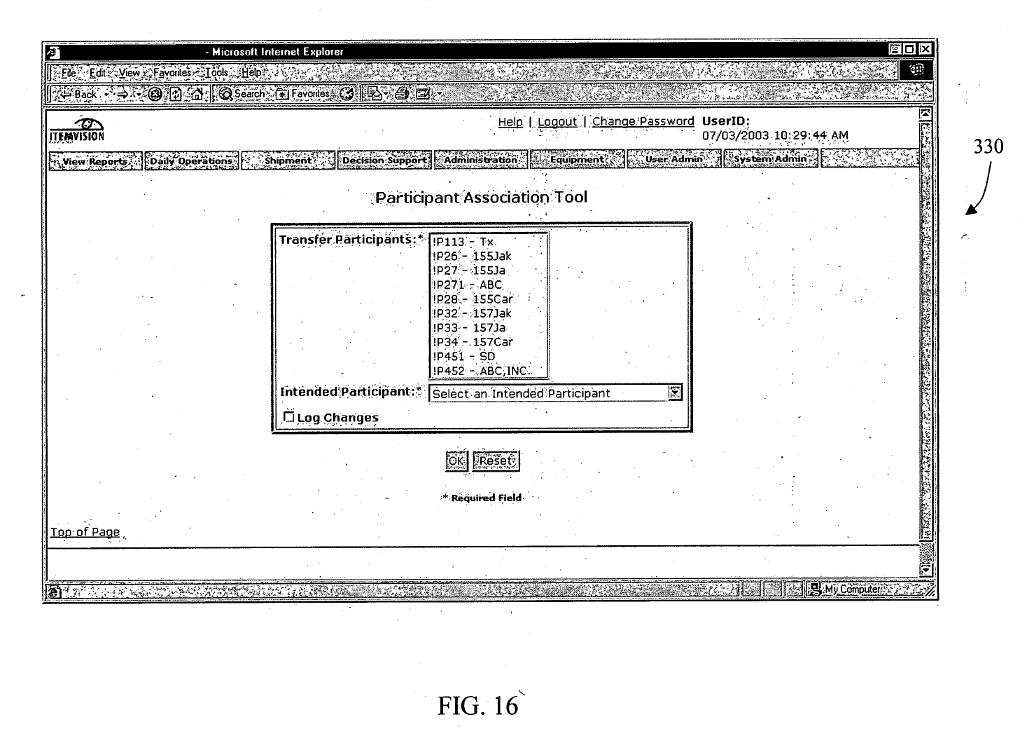

FIG. 15 is an example embodiment of a user interface 320 illustrating a relationship list web page provided after a search of the participant identifier “ABC”. As shown on the web page, the participant whose identifier is “ABC” is “ABC Company” uses the context “ABC” when they sell to target participant “LLL Baking Company”. ABC Company utilizes the contextual identifier “LBC” to identify sales to LLL Baking Company.

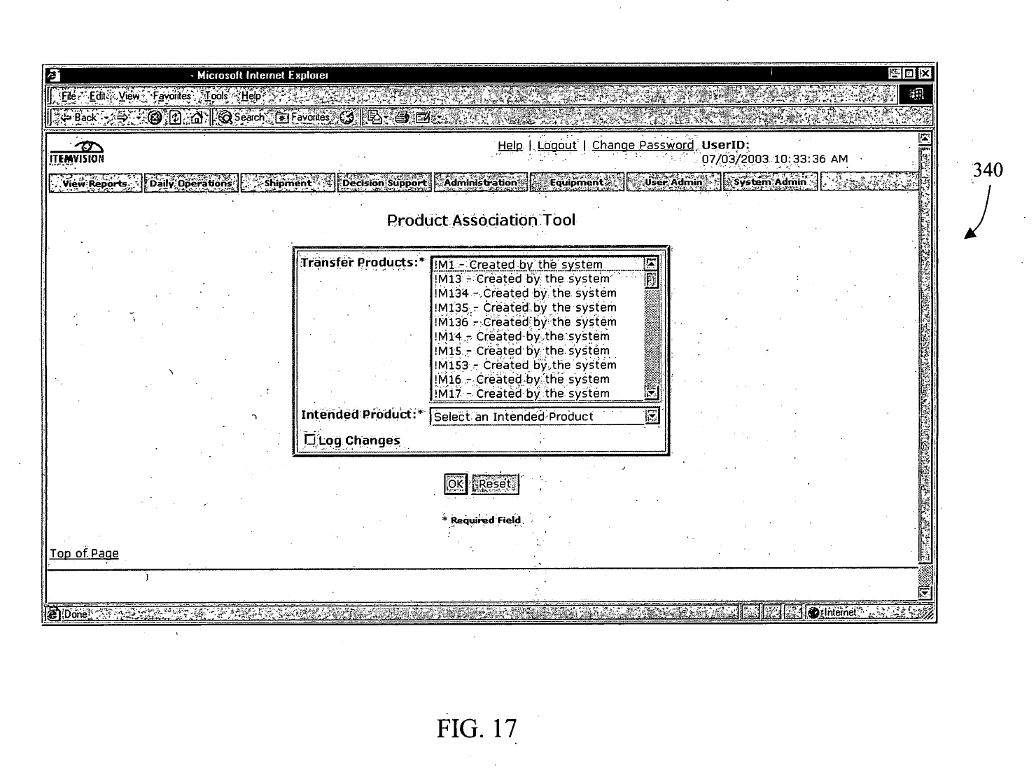

FIG. 16 is an example embodiment of a user interface 330 illustrating a participant association tool web page. This page is utilized to associate various participant identifiers, which all refer to a single participant with that participant's identifier as recognized in the supply chain.

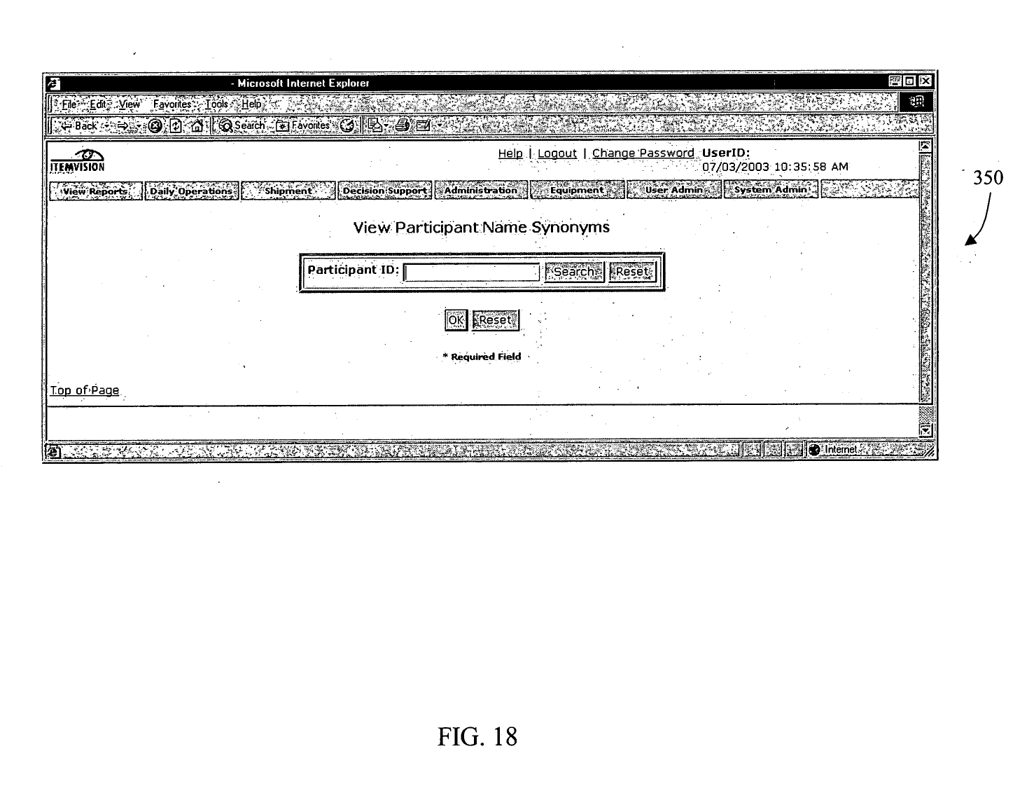

FIG. 17 is an example embodiment of a user interface 340 illustrating a product association tool web page. A product is the identifier, description, and base unit-of-measure for a product within the supply chain context. A base unit-of-measure is the lowest level at which a product will be tracked within the supply chain, and is also the common reporting unit-of-measure. Participants within a supply chain often have their own view of a supply chain product. The association tool allows a user to associate a participant's view of a product, to the supply chain's view of the product. Also, each participant may have one or more product views which associate its identifiers and descriptions to various supply chain product. The association tool is part of a comprehensive package that aggregates availability information across all product views that refer to the same product.

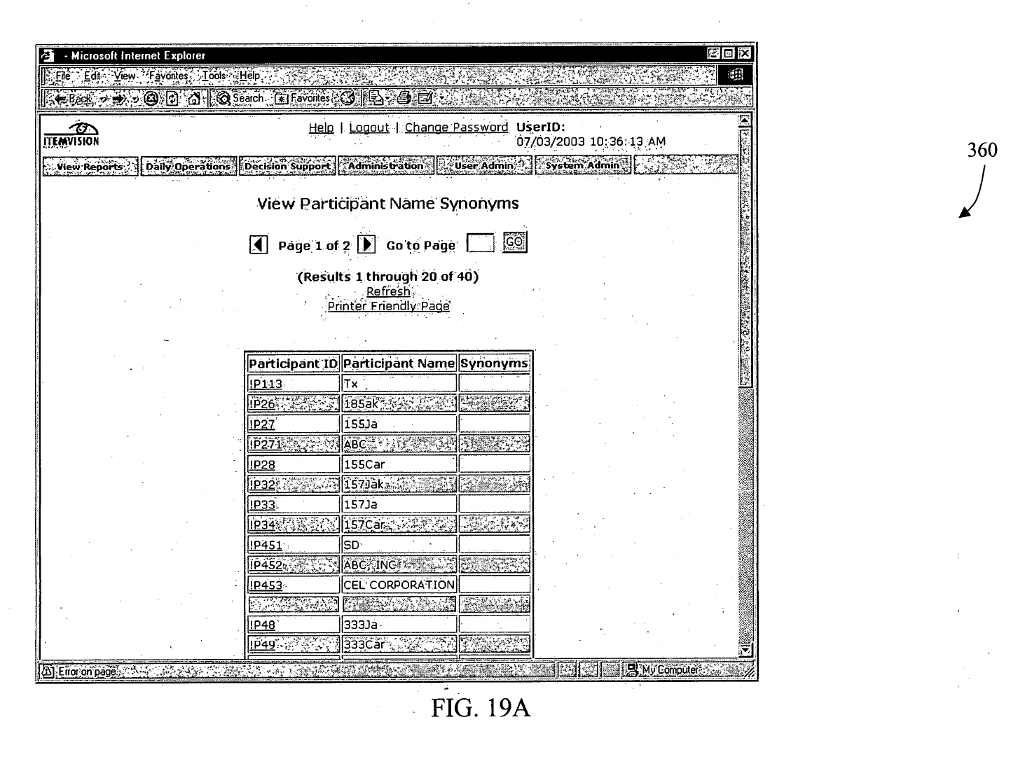

FIG. 18 is an example embodiment of a user interface 350 illustrating a view participant name synonyms web page utilized to initiate a search for synonyms for a participant identifier.

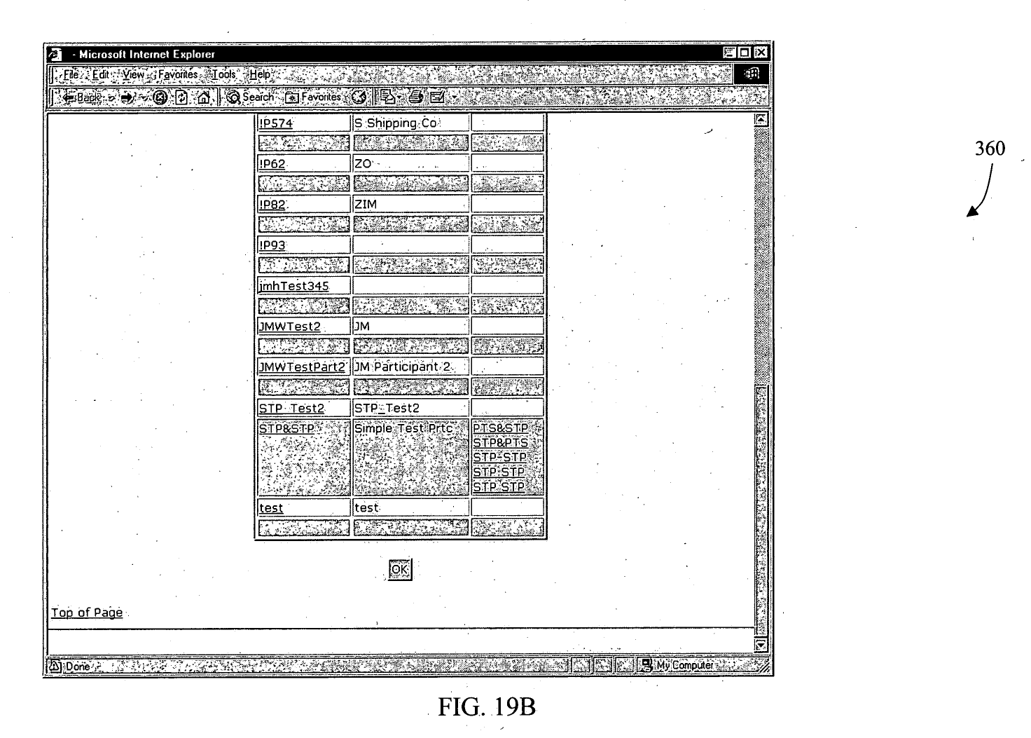

FIGS. 19A and 19B are an example embodiment of a user interface 360 of a view participant name synonyms for showing results of a synonym search. Specifically, and as shown in FIG. 19B, for a participant identifier of “STP&STP”, the participant name being “Simple Test Prtc”, the synonyms “PTS&STP”, “STP&PTS”, “STP-STP”, “STP.STP”, and “STP_STP” are all utilized in to identify Simple Test Prtc by various supply chain participants.

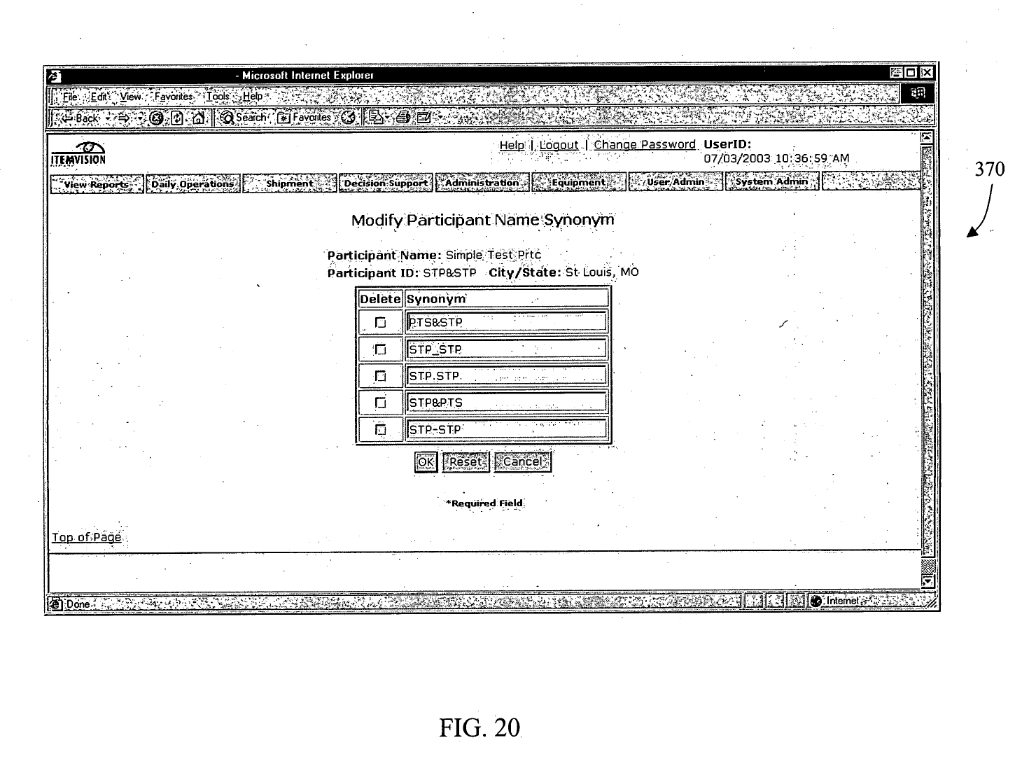

FIG. 20 is an example embodiment of a user interface 370 modify participant name synonyms web page utilized to modify or delete synonyms for a participant. In the specific example shown in FIG. 20, for the participant “Simple Test Prtc”, who is in one instance identified by the participant identifier “STP&STP”, the user has the capability of editing or deleting the other synonyms for “Simple Test Prtc”. Specifically, the user can either select a deletion check box for any or all of the synonyms “PTS&STP”, “STP&PTS”, “STP-STP”, “STP.STP”, and “STP_STP”. Alternatively, the user might edit one or more of the synonyms.

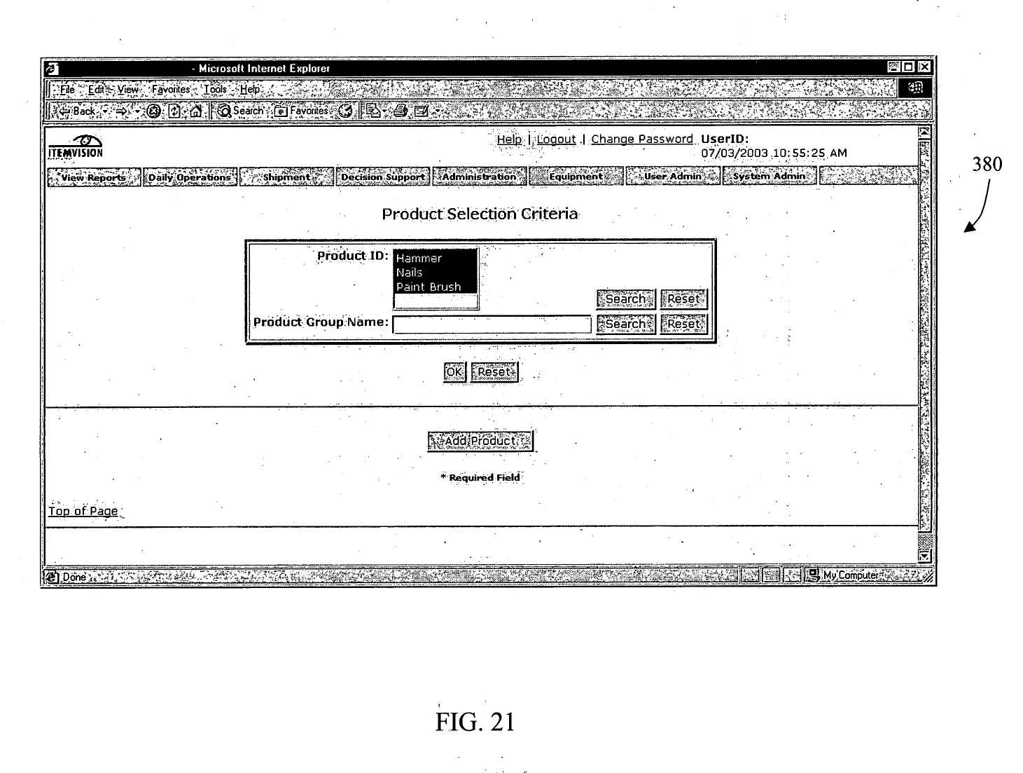

FIG. 21 is an example embodiment of a user interface 380 illustrating a product selection criteria web page. By selecting one or more products, a user is able to utilize product identifiers as well as participant identifiers to uniquely identify participants to a transaction.

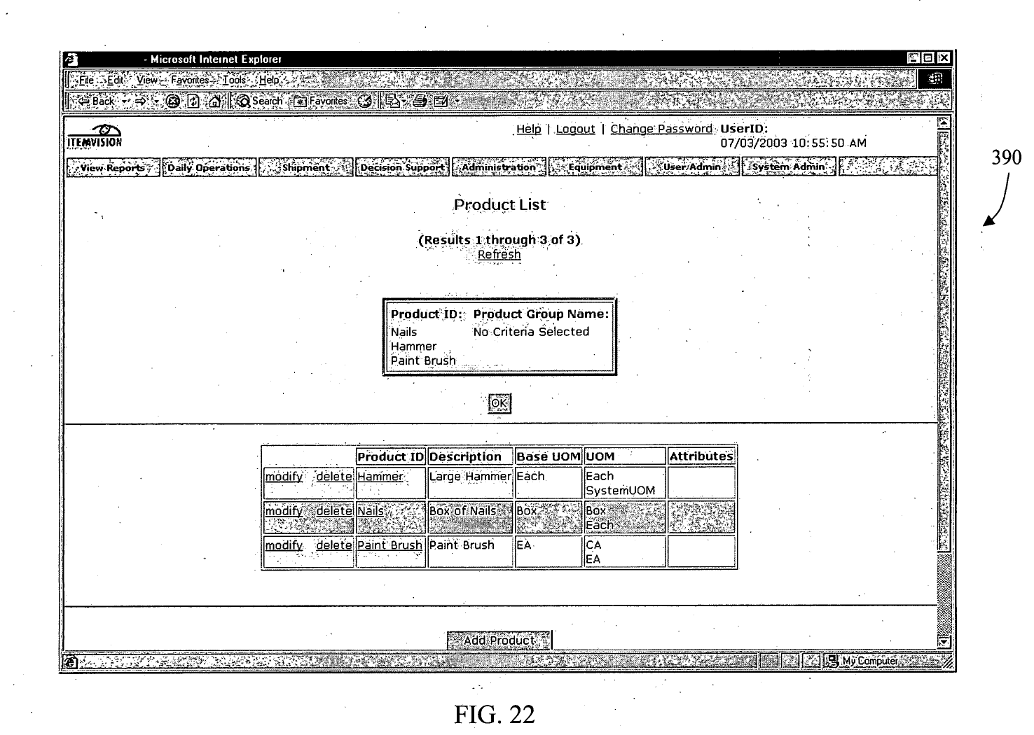

FIG. 22 is an example embodiment of a user interface 390 illustrating a product list web page. Product identifiers are utilized to identify certain products. For example, a product identifier of “hammer”, is utilized to identify a large hammer, which has a base unit of measure of “each”. The product identifier is utilized to describe a box of nails, which has a base unit of measure of “box”. Another unit of measure for nails is “each”, as shown in screen shot 390.

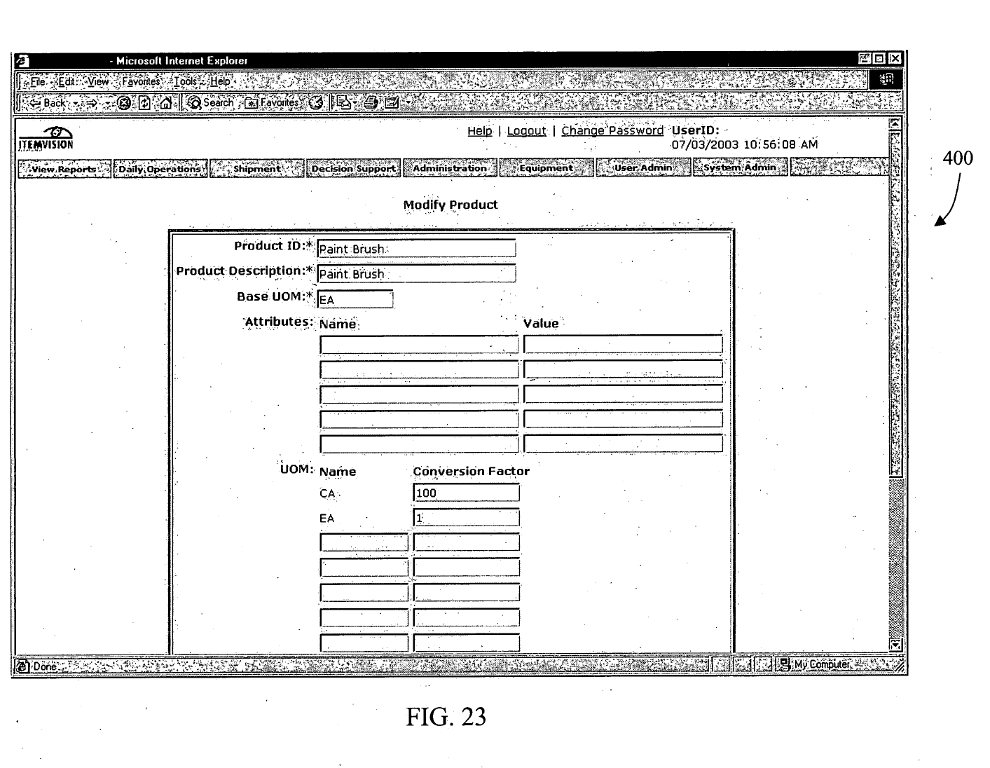

FIG. 23 is an example embodiment of a user interface 400 illustrating a modify product web page. A user can utilize the modify product web page to modify certain aspects of a product that is identified by a particular product identifier. For example, the product identifier “paint brush” has a product description of “paint brush” with a base unit of measure of “each”. Other attributes can be added to the product identifier, as can other units of measure.

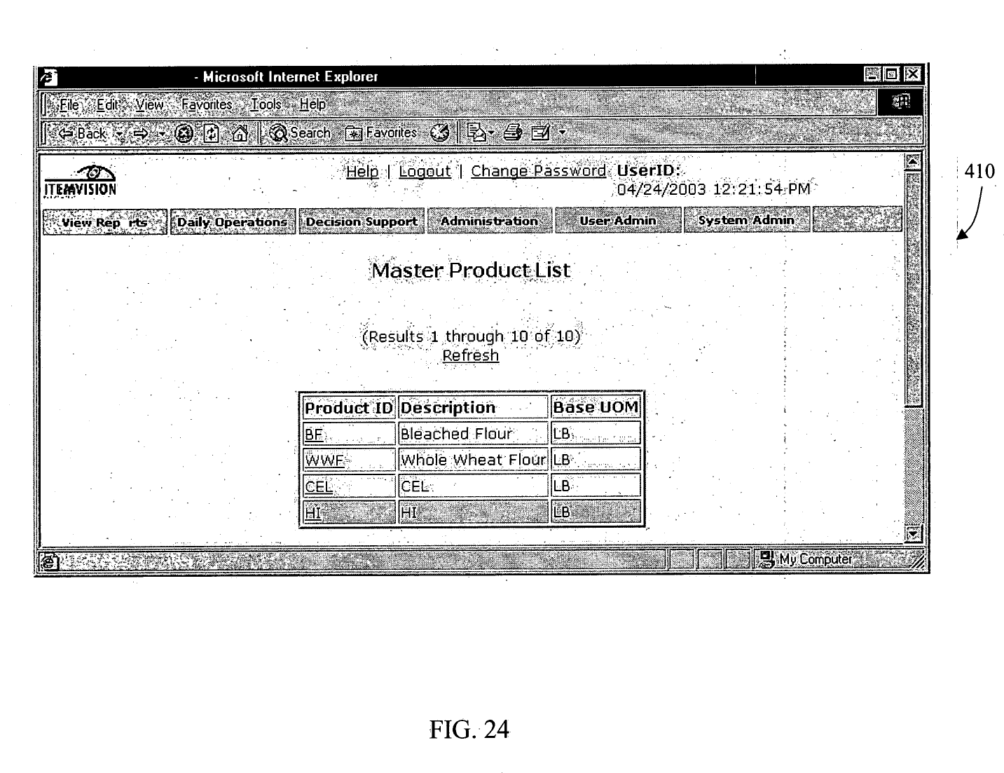

FIG. 24 is an example embodiment of a user interface 410 illustrating a master product list web page. Example product identifiers include “BF” and “WWF” which are respectively utilized to identify the products “bleached flour” and “whole wheat flour” utilized in baking and other food related industries. A base unit of measure for the product is also shown. For the above example the base unit of measure is “LB” for pounds.

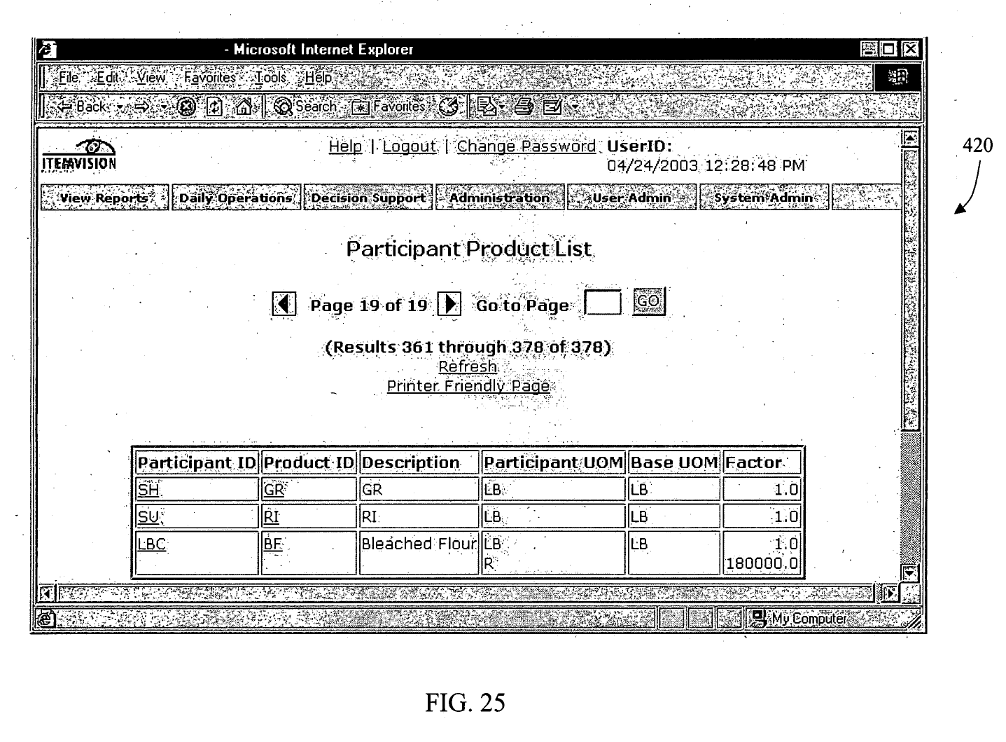

FIG. 25 is an example embodiment of a user interface 420 illustrating a participant product list web page. Participant identifiers and their various products, identified by product identifiers are shown. For each product identifier of each participant, a product description, participant unit of measure, a base unit of measure, and a factor are shown. The factor is a conversion between the participant unit of measure and the base unit of measure. Unit-of-measure conversions are utilized to allow each participant in the supply chain to buy and sell products in units other than the supply chain product's base unit-of-measure. Unit-of-measure conversions, in one embodiment, are anchored to the associated supply chain product's base unit-of-measure, and there may be many unit-of-measure conversions for each supply chain product.

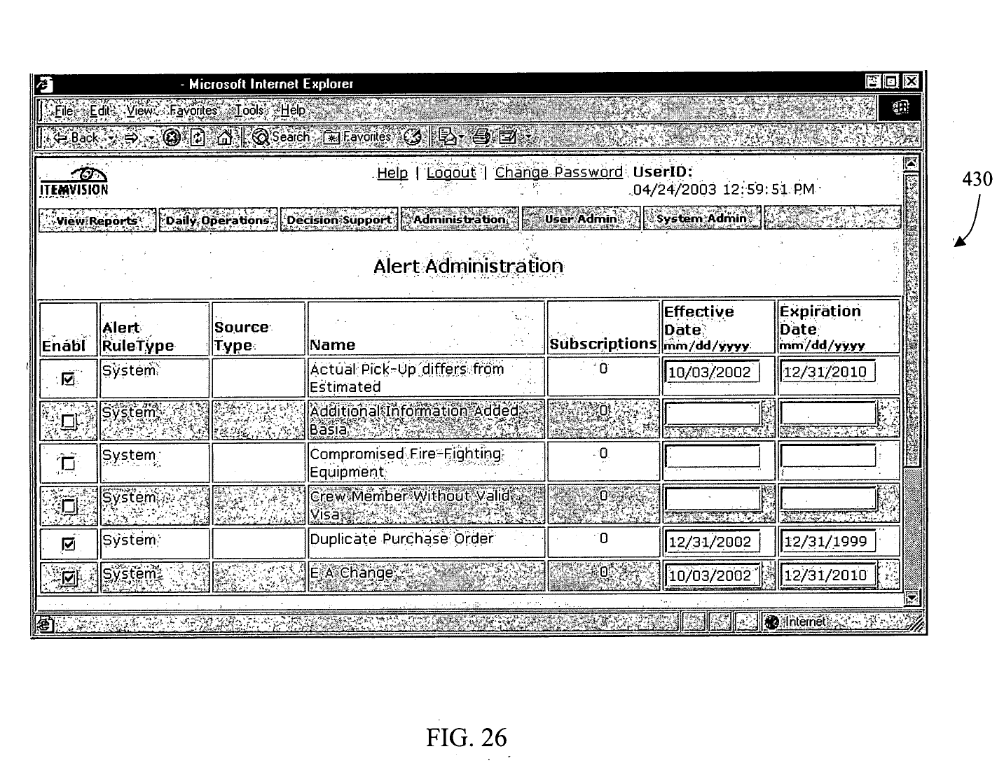

FIG. 26 is an example embodiment of a user interface 430 illustrating an alert administration web page. As used herein, an alert is a system message generated upon certain conditions being met, for example, an anticipated shortfall in an inventory of a component for a product (e.g., whole wheat flour). Alert conditions may be pre-defined or customized for particular supply chains. Certain components that might cause an alert include, but are not limited to, a facility, facility receipt, master product, product request, raw materials requisition, and shipment. As shown in FIG. 26, alerts can be enabled or disabled and include an effective date and an expiration date.

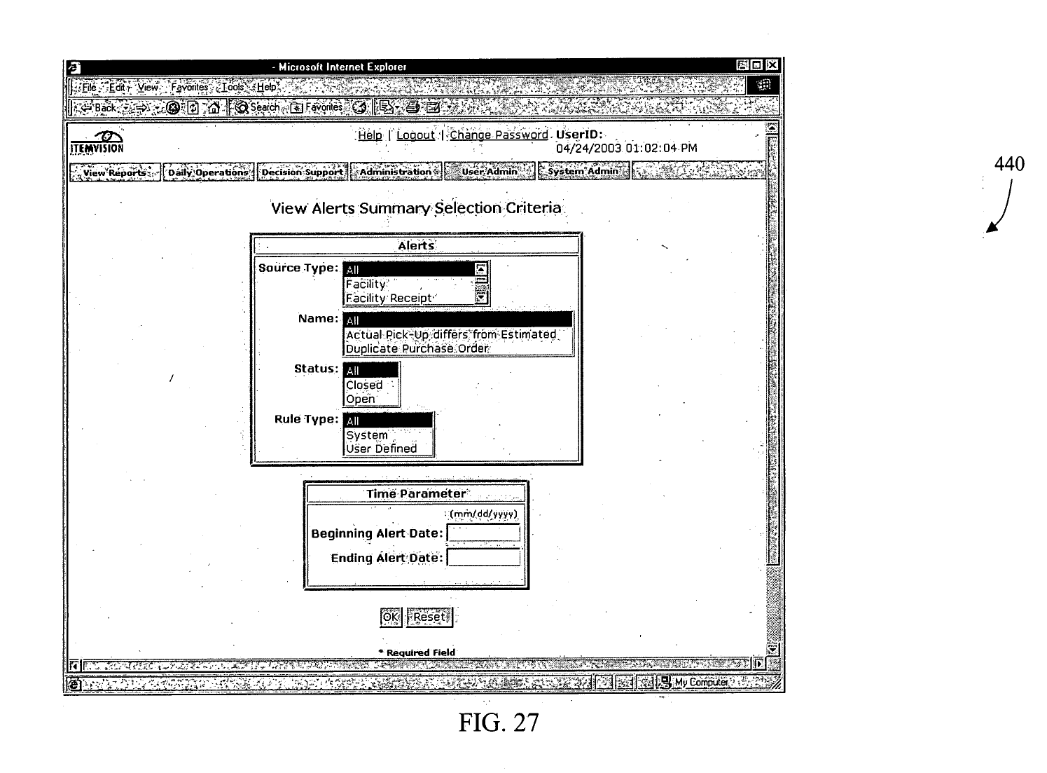

FIG. 27 is an example embodiment of a user interface 440 illustrating a view alerts summary selection criteria web page, for example, to prepare a custom alert message. In FIG. 27, a user is able to select at least one of a source type for an alert, a name for the alerts, a status of the alerts, and a rule type for the alerts. A timing parameter for the alerts, as described above, with a beginning date and an ending date can also be entered.

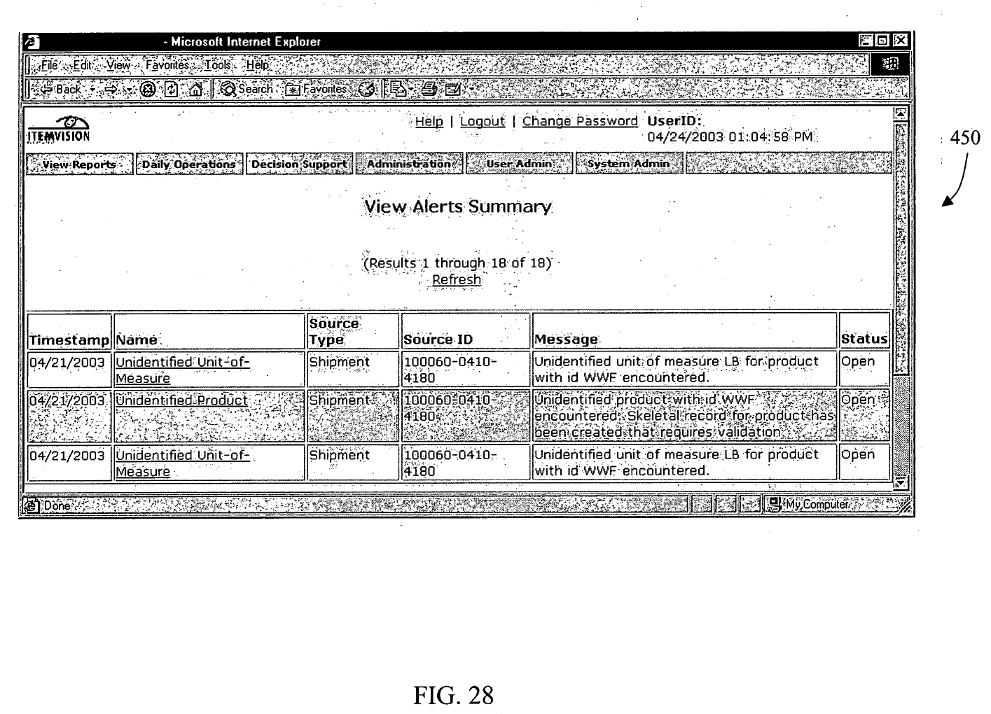

FIG. 28 is an example embodiment of a user interface 450 illustrating a view alerts summary web page which illustrates outstanding alerts. In the example embodiment, the alerts include an unidentified unit-of-measure that has been encountered in an electronic message between participants. In another example embodiment, an alert includes an unidentified product. In still another example embodiment, an alert alerts the user to an unidentified unit-of-measure.

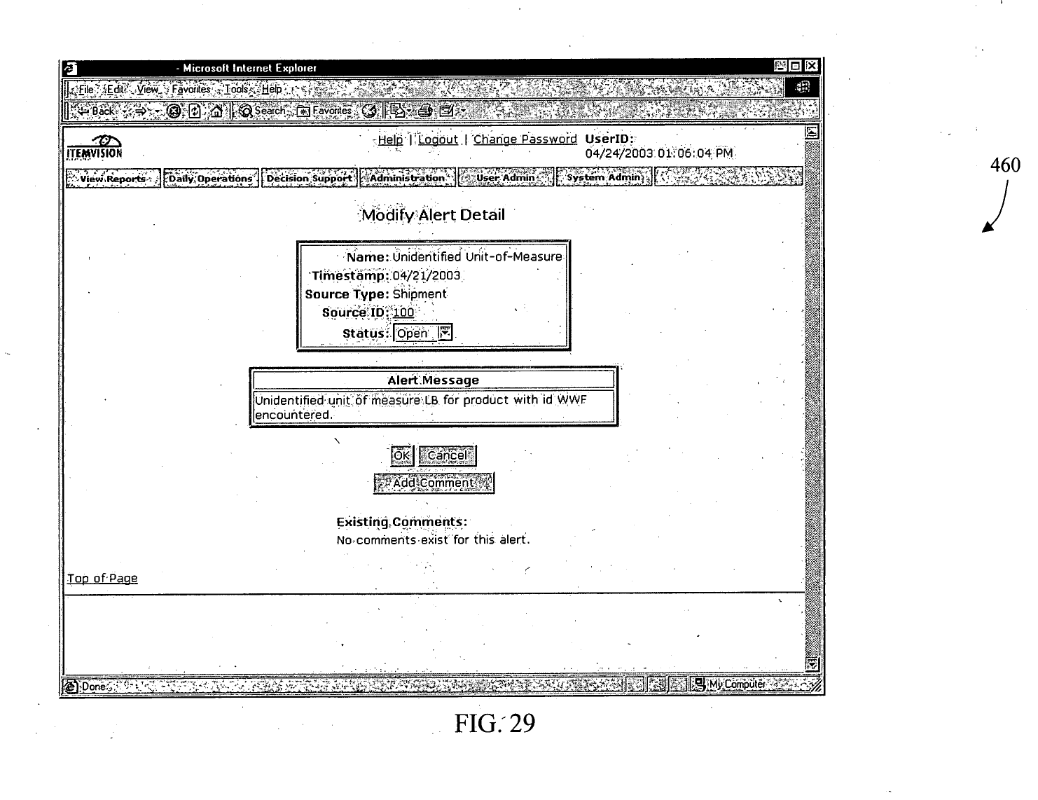

FIG. 29 is an example embodiment of a user interface 460 illustrating a modify alert detail web page, which provides additional details to an alert that was selected from the view alerts summary web page (shown in FIG. 28). Further, the user is able to modify the details of the alert, for example, whether the status of the alert is open or closed.

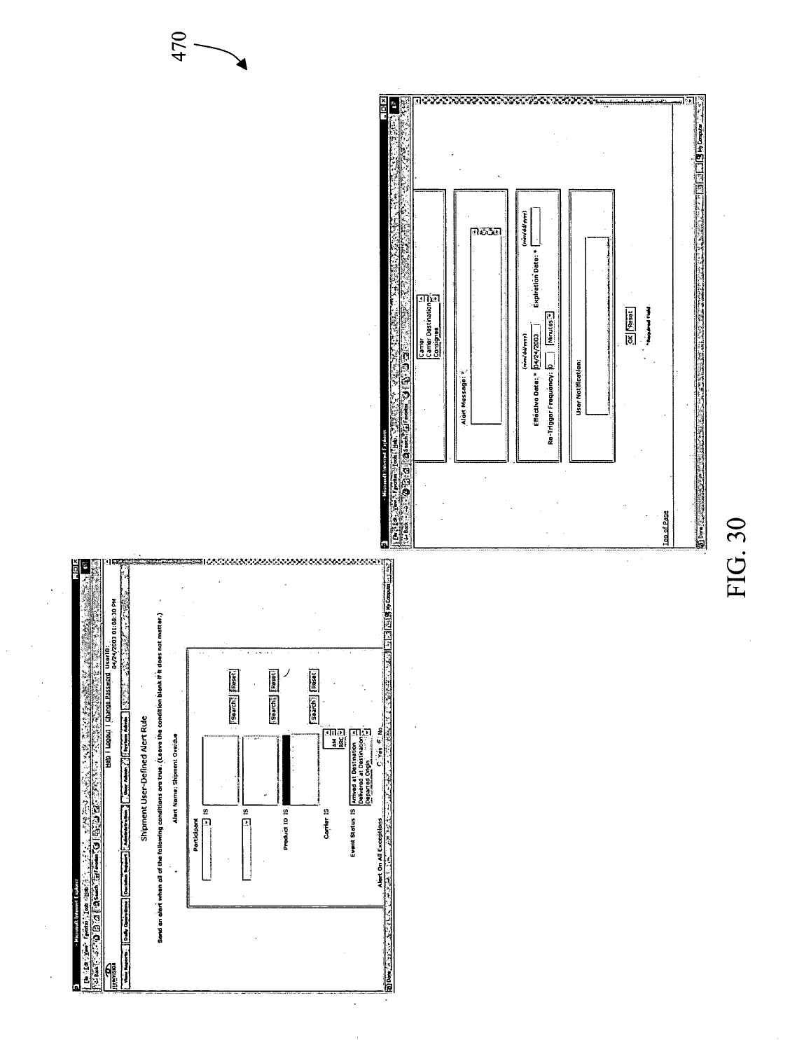

FIG. 30 is an example embodiment of a user interface 470 illustrating portions of a shipment user-defined alert rule web page. Utilizing this web page a user is able to define the conditions which cause an alert. In the example illustrated, the user is defining a shipment overdue alert, and can select the participants, products, carrier, events, dates, user to be notified, and a notification message related to the custom alert.

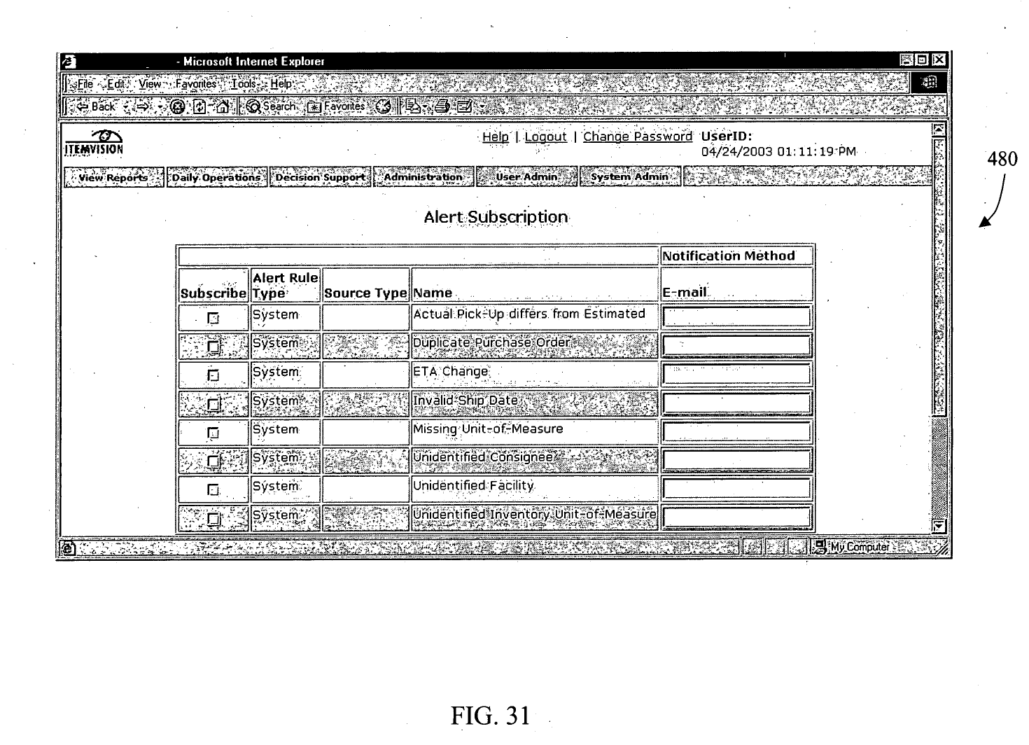

FIG. 31 is an example embodiment of a user interface 480 illustrating an alert subscription web page. In the example embodiment, the user can select which of the defined alerts they wish to subscribe to by simply selecting a subscribe selection box. Further the type of notification can also be selected, for example, electronic mail or pager.

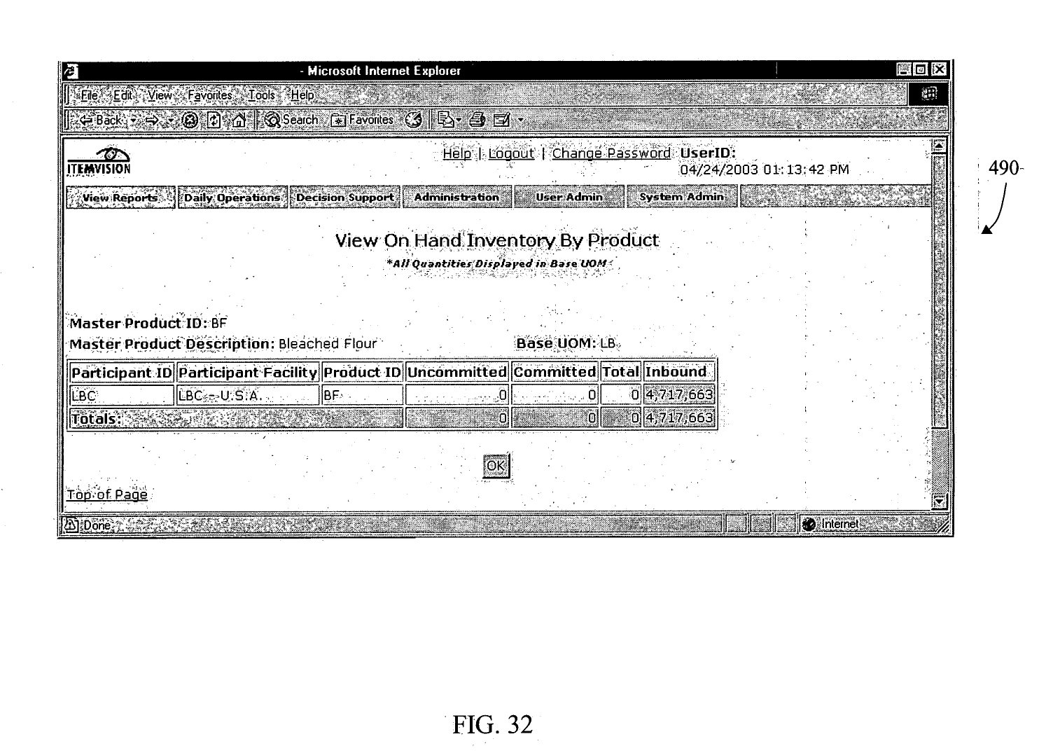

FIG. 32 is an example embodiment of a user interface 490 illustrating a view on hand inventory by product web page. Utilizing this web page a user can select a product and view all participants that are engaged with the selected product. The user is able to see the participant identifiers, the participant facilities, the participant's product identifier, and data relating to the disposition of the product.

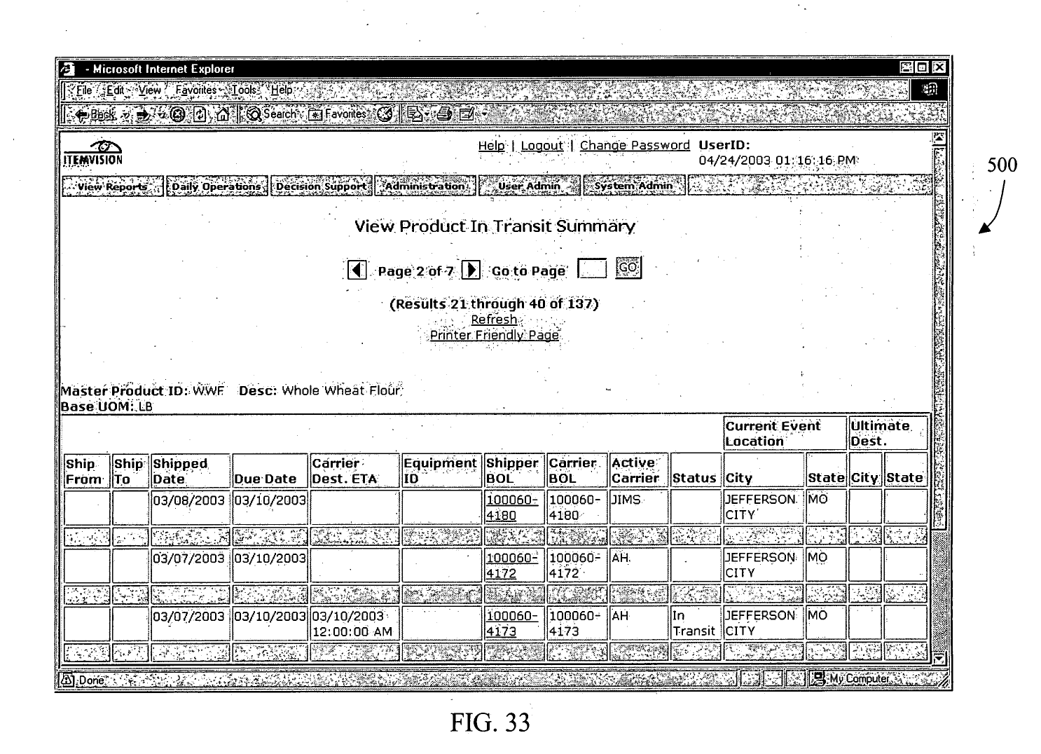

FIG. 33 is an example embodiment of a user interface 500 illustrating a view product in transit summary web page. The user is able to verify status on any or all products in transit, including to and from information, dates shipped and due (including an estimate of arrival time), shipper and carrier bill of lading data, current event location and an ultimate destination.

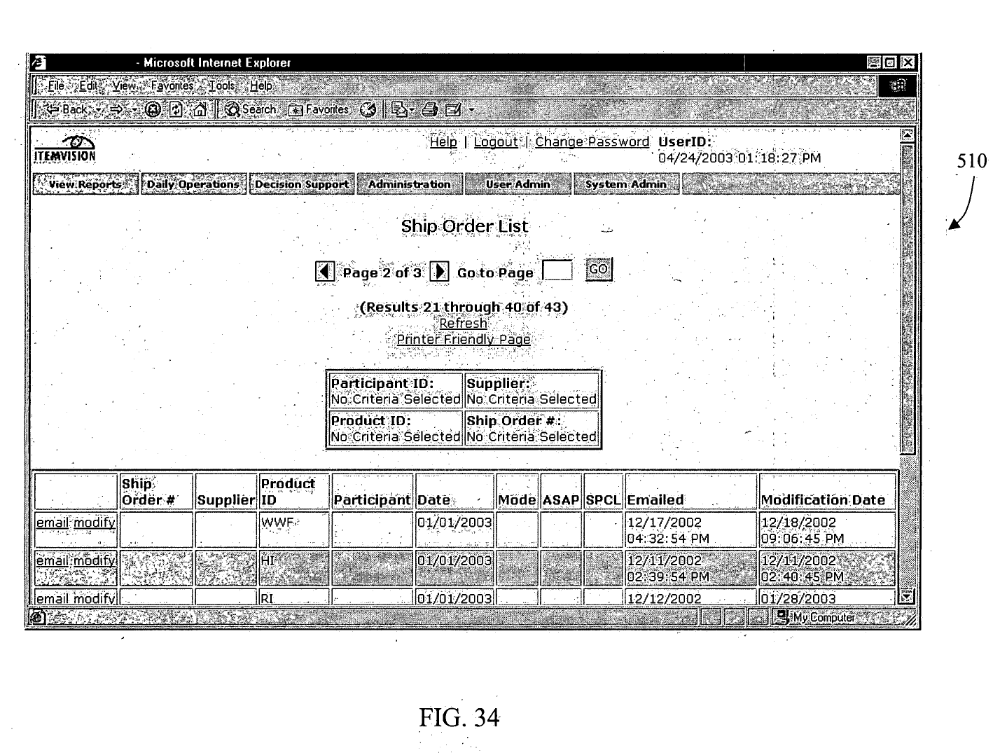

FIG. 34 is an example embodiment of a user interface 510 illustrating a ship order list web page. A user utilizes this web page to view information relating to individual shipping orders. For example, for each order, a ship order number, a supplier, a product identifier, a participant, a date of the order, a mode of transport, and dates relating to the making and modification of the order are shown.

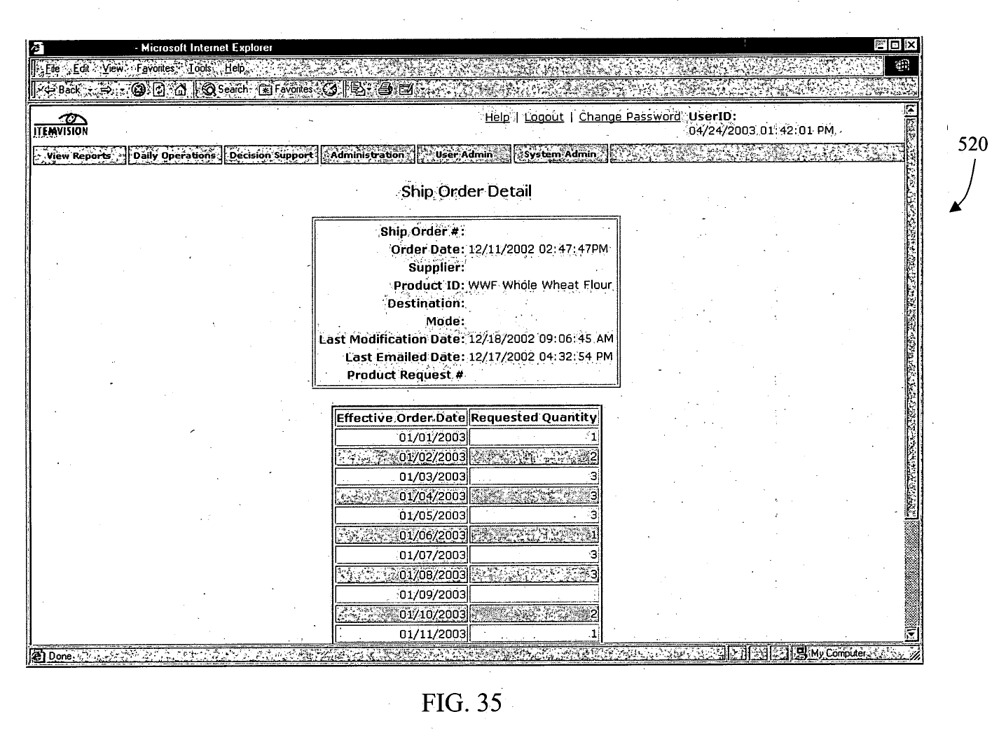

FIG. 35 is an example embodiment of a user interface 520 illustrating a ship order detail web page, detailing one of the ship orders selected from the ship order list web page (shown in FIG. 34). The user is able to all data relating to specific orders, including, effective order dates, and quantity for each of the orders.

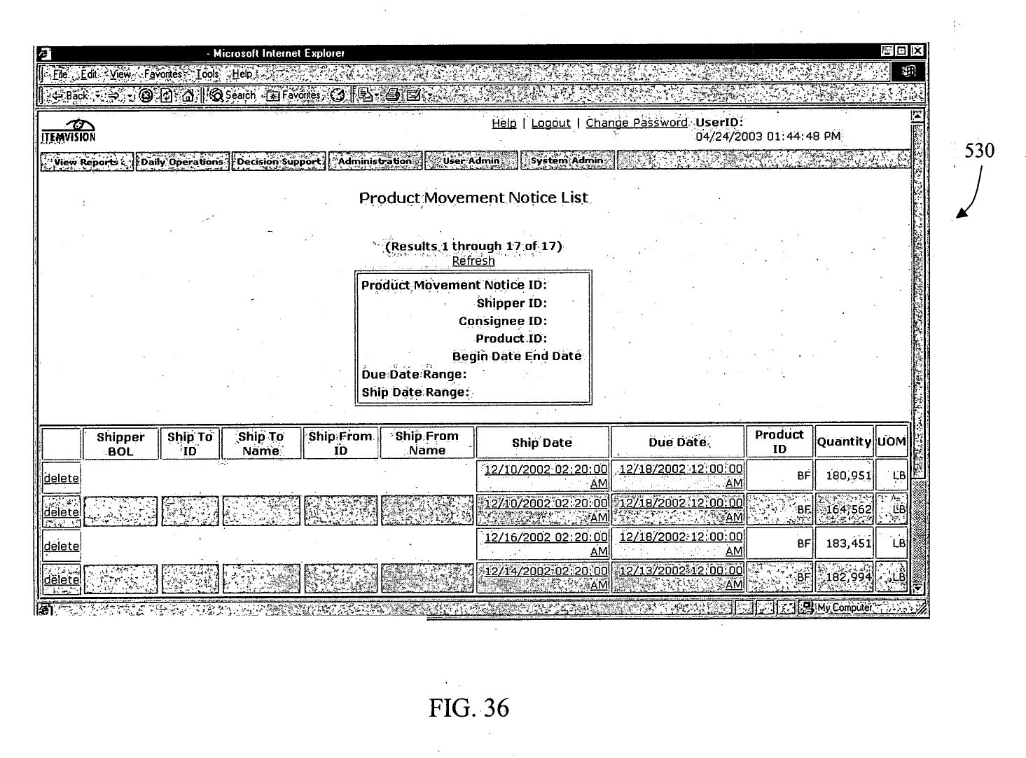

FIG. 36 is an example embodiment of a user interface 530 illustrating a product movement notice list web page which illustrates movements of products from facility to facility within the supply chain, including shipper bill of lading, a ship to identifier, a ship to name, a ship from identifier, a ship date, a due date, a product identifier, a quantity and a unit-of-measure.

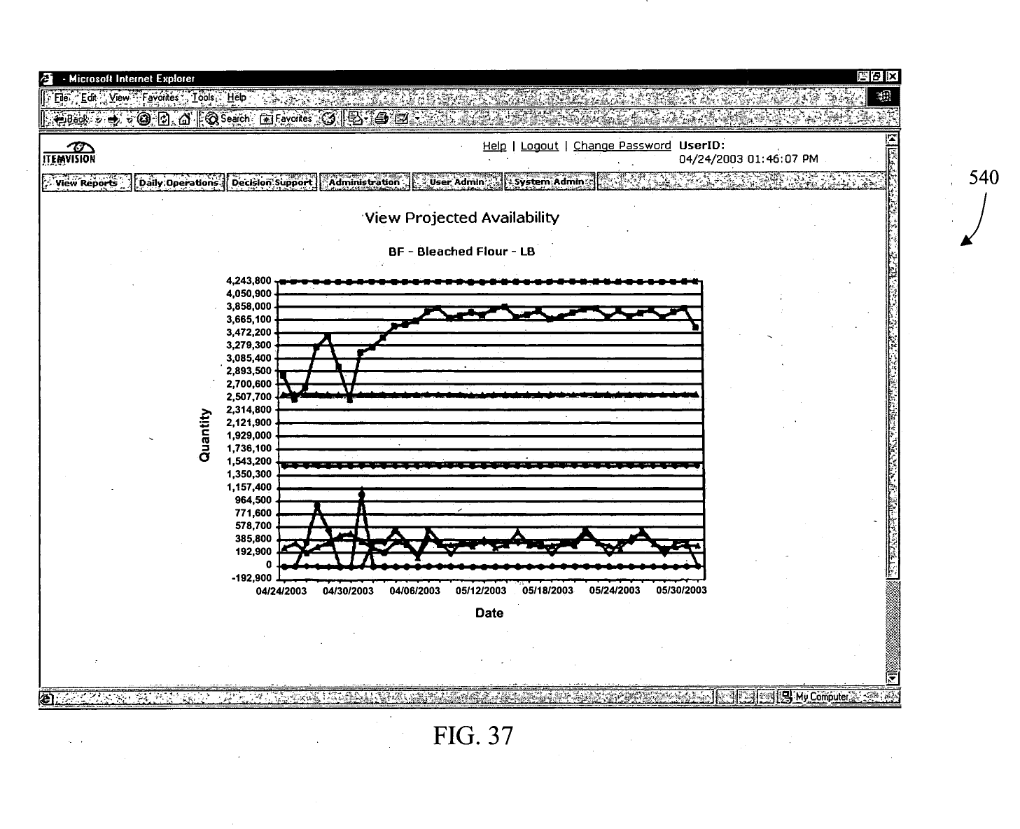

FIG. 37 is an example embodiment of a user interface 540 illustrating a view projected availability web page. The user is able to view product availability for a selected product based upon the order data received and shipping data received.

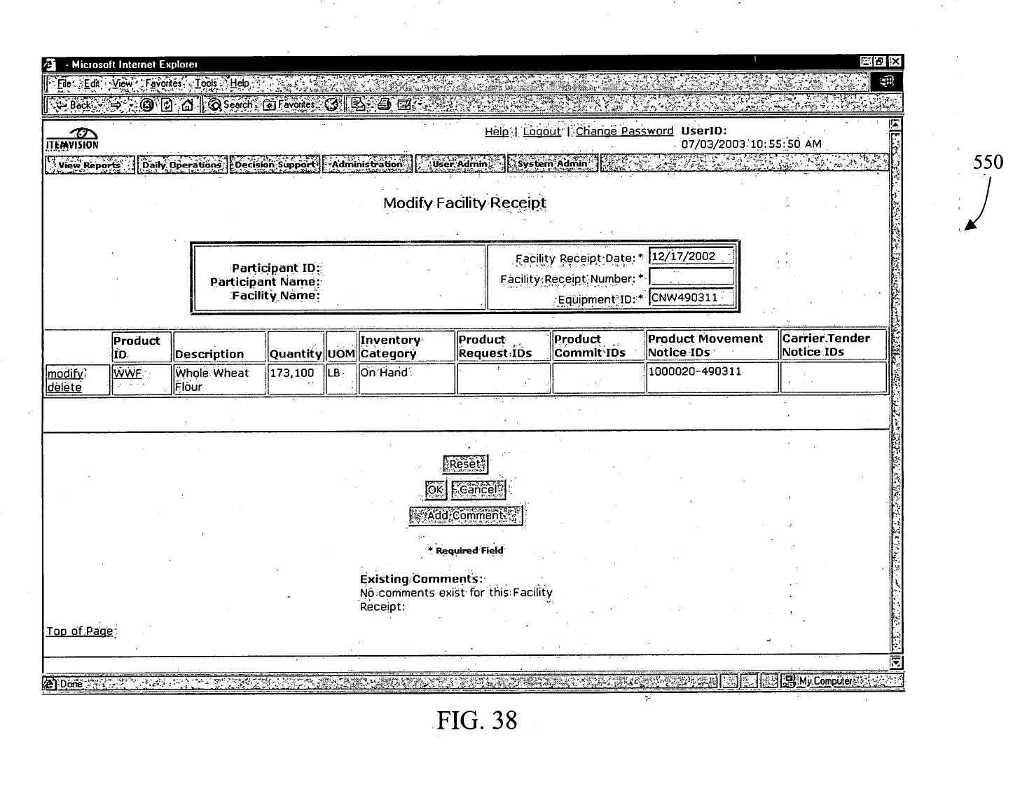

FIG. 38 is an example embodiment of a user interface 550 illustrating a modify facility receipt web page where for a selected product, a user can enter a date at which an ordered product has been received at a facility. In FIG. 38, an order of “whole wheat flour” is being modified to be received on December 17.

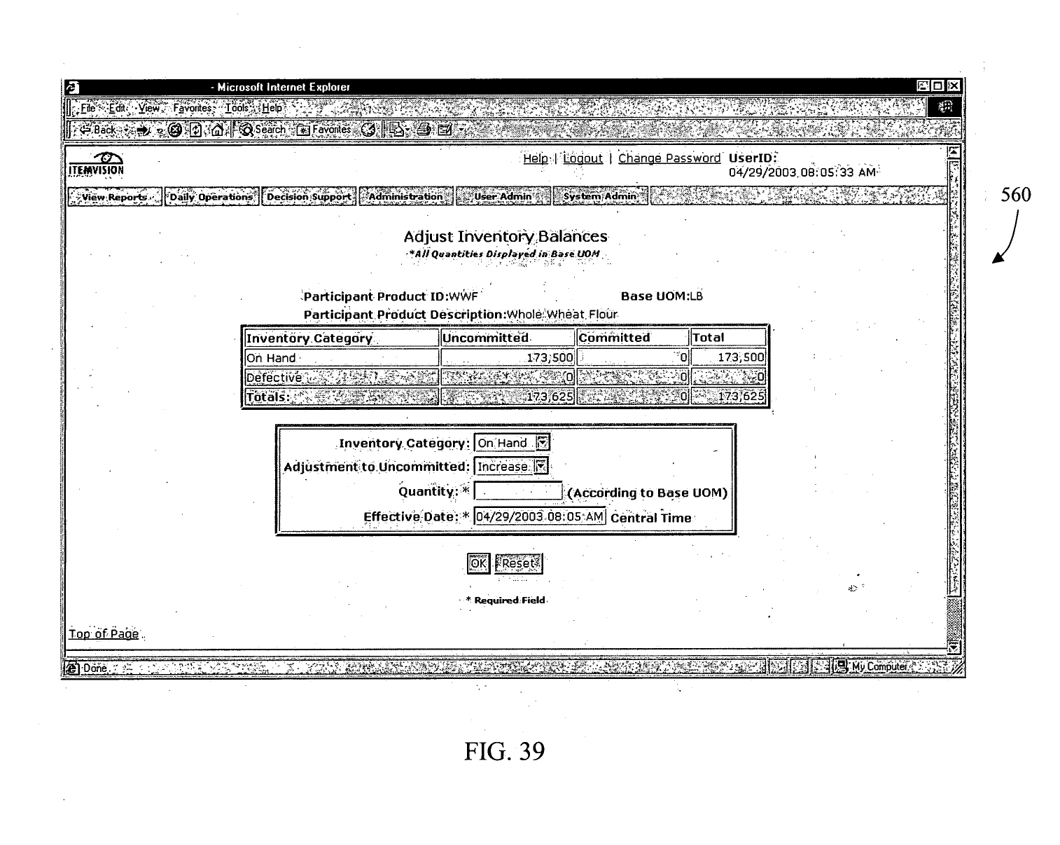

FIG. 39 is an example embodiment of a user interface 560 illustrating an adjust inventory balances web page where a user can update the inventory for a product at a facility, including an amount of the product that is acceptable for use, and is considered on hand, and an amount of product at the facility that has been rejected for use.

Through utilization of the systems and methods described herein, an entity can track inventory items, whether in transit or in storage. The information is aggregated so the entire inventory position for the entity is captured, rather than just items in transit. Further a real time interface with all trading partners is created, because capture of all of the electronic messages between trading partners is captured. Therefore, complete inventory information is provided that allows improved management of a supply chain, as participant and product identities are reconciled and associations from participant products to supply chain products are made, regardless of identity differences.

While the invention has been described in terms of various specific embodiments, those skilled in the art will recognize that the invention can be practiced with modification.

1. A method for managing supply chain relationships between a plurality of participants, said method comprising:
receiving electronic messages exchanged between the supply chain participants utilizing a computer;
parsing the received messages with the computer for one or more of participant identifier information and contextual data relating to a business event;
analyzing a performance criteria for the supply chain based on data parsed from the electronic messages; and
providing data relating to supply chain management to the relevant participants based on the analysis.

2. A method according to claim 1 further comprising parsing the received messages for one or more of product identifiers and unit of measure data for the products.

3. A method according to claim 1 wherein parsing the received messages comprises parsing the data for industry identifiers for the participants.

4. A method according to claim 1 wherein parsing the received messages comprises parsing the data for names and addresses for the participants.

5. A method according to claim 1 further comprising reconciling identities of the participants based on the contextual data relating to a business event received.

6. A method according to claim 5 wherein the contextual data relating to a business event comprises roles for the participants.

7. A method according to claim 6 wherein the roles for the participants comprise one or more of buys from, sells to, bills to pays to, receives payment from, ships to, and receives from.

8. A method according to claim 1 further comprising implementing an algorithm to identify individual participants based upon their function included in the contextual relationship data.

9. A method according to claim 1 wherein receiving electronic messages comprises passively observing messages transferred between participants utilizing a web hosting module.

10. A method according to claim 1 wherein any unit-of-measure data for product identifiers within the electronic messages are factored to be based upon a base unit-of-measure for the respective products as defined in the supply chain.

11. A method for resolving the identities of the parties to a transaction from an electronic message received at a computer, said method comprising:
identifying an originator of the transaction;
determining a context of the transaction;
finding an appropriate identifier in a database for the originator and context; and
reconciling an identity for the receiver of the message based upon the originator, the context, and the identifier in the database for the originator and context.

12. A method according to claim 11 wherein identifying an originator of the transaction comprises recognizing at least one of a participant identifier, a product identifier, and a unit-of-measure within the electronic message received.

13. A method according to claim 11 further comprising reconciling an identity of the participants utilizing at least an industry identifier.

14. A method according to claim 11 further comprising reconciling an identity of the participants utilizing at least an assigned identifier.

15. A method according to claim 11 further comprising:
reconciling an identity of the participants utilizing at least name and address data for the participants; and
setting a synonym flag indicating that the identifiers for the participants sharing the same address are synonymous.

16. A method according to claim 11 further comprising permissively adding a participant identifier for a participant whose identity cannot be reconciled.

17. A computer programmed to:
passively observe messages transmitted between participants in a supply chain;
identify originators of the messages based on the transmitted data;
determine contexts for the observed messages;
find appropriate identifiers in a database for the originators and respective contexts; and
reconcile identities of the receivers of the messages based upon the originators, the contexts, and the identifiers in the database for the originators and respective contexts.

18. A computer according to claim 17 further programmed to parse the observed messages for one or more of product identifiers and unit-of-measure data relating to the product identifiers.

19. A computer according to claim 17 wherein the identifiers comprise at least one of industry identifiers, assigned identifiers, and name and address data.

20. A computer according to claim 17 wherein the context comprises a business event.

21. A computer according to claim 17 wherein to passively observe messages transmitted between participants, said computer is configured with a web hosting module.

22. A computer program product comprising:
a software module for passively receiving transmissions between participants in a supply chain;
a software module for parsing the received transmissions for one or more of participant identifiers, product identifiers, and name and address data for the participants;
a software module for comparing the one or more of participant identifiers, product identifiers, and name and address data with participant identifiers, product identifiers, and name and address data stored in a database; and
a software module for reconciling identities of the participants based on the comparison.
